(19) United States
(12) Patent Application Publication
(10) Pub. No.: US 2020/0090120 A1
(43) Pub. Date: Mar. 19, 2020

(54) CALCULATION OF A TRANSPORTATION ROUTE BASED ON A CHARACTERISTIC CHANGE OF A PART DURING TRANSPORTATION

(71) Applicant: FUJITSU LIMITED, Kawasaki-shi (JP)

(72) Inventors: Tomokazu NAKASHIMA, Kawasaki (JP); MICHIKO NARITA, Yokohama (JP); Masayuki ITOH, Kawasaki (JP)

(73) Assignee: FUJITSU LIMITED, Kawasaki-shi (JP)

(21) Appl. No.: 16/540,125

(22) Filed: Aug. 14, 2019

(30) Foreign Application Priority Data
Sep. 18, 2018 (JP) 2018-174269

(51) Int. Cl. G06Q 10/08

(52) U.S. Cl. CPC G06Q 10/08355; G01C 21/3453

(57) ABSTRACT

An apparatus refers to information indicating relationships between conditions when a part is transported, transportation times of the part, and characteristic changes of the part, and makes a determination of whether or not a characteristic change of the part corresponding to a transportation time required when a first transportation route is passed through exceeds a threshold value based on conditions when the first transportation route is used for transporting the part. When it has been determined that the threshold value is not exceeded, the apparatus outputs information for identifying the first transportation route, and when it has been determined that the threshold value is exceeded, the apparatus makes the determination with respect to a second transportation route different from the first transportation route.

### CROSS-REFERENCE TO RELATED APPLICATION

This application is based upon and claims the benefit of priority of the prior Japanese Patent Application No. 2018-174269, filed on Sep. 18, 2018, the entire contents of which are incorporated herein by reference.

### FIELD

The embodiment discussed herein is related to calculation of a transportation route based on a characteristic change of a part during transportation.

### BACKGROUND

When a plurality of parts are assembled to manufacture a product, it is sometimes determined which of a plurality of manufacturing locations is to be used to manufacture the product. In this case, according to one method, a transportation period and a transportation cost required when transporting a part from a part production place of each part vendor to each manufacturing location are evaluated to decide on a manufacturing location and a part vendor, for example.

Japanese Laid-open Patent Publication No. 2011-86017, for example, describes a technique of, when an abnormal quality of a product is detected, choosing a product that is less likely to have an abnormal quality owing to temperature, humidity, or a shock from among a stock of products based on information regarding the temperature, humidity, and shocks of the product and a control room, and position information regarding delivery equipment.

### SUMMARY

According to an aspect of the embodiment, an apparatus refers to information indicating relationships between conditions when a part is transported, transportation times of the part, and characteristic changes of the part, and makes a determination of whether or not a characteristic change of the part corresponding to a transportation time required when a first transportation route is passed through exceeds a threshold value based on conditions when the first transportation route is used for transporting the part. When it has been determined that the threshold value is not exceeded, the apparatus outputs information for identifying the first transportation route, and when it has been determined that the threshold value is exceeded, the apparatus makes the determination with respect to a second transportation route different from the first transportation route.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a transportation route calculation method according to an embodiment;

FIG. 2 is an explanatory diagram illustrating an exemplary system configuration of a system;

FIG. 3 is a block diagram illustrating an exemplary hardware configuration of an information processing device;

FIG. 4 is an explanatory diagram illustrating a specific example of a vendor information table in a part DB;

FIGS. 5A-1 to 5A-3 depict first explanatory diagrams illustrating a specific example of evaluation information in a part DB;

FIGS. 5B-1 to 5B-3 depict second explanatory diagrams illustrating a specific example of evaluation information in a part DB;

FIG. 6 is an explanatory diagram illustrating a specific example of a part list in a device DB;

FIG. 7 is an explanatory diagram illustrating a specific example of an allowable range table in a device DB;

FIG. 8 is an explanatory diagram illustrating a specific example of a manufacturing location table in a manufacture DB;

FIG. 9 is an explanatory diagram illustrating an example of contents stored in a transportation condition DB;

FIG. 10 is a block diagram illustrating an exemplary functional structure of an information processing device;

FIG. 11 is an explanatory diagram illustrating an example of a calculation of an approximation of a characteristic change;

FIGS. 12A and 12B depict first explanatory diagrams illustrating an example of a calculation of an amount of characteristic change of a part;

FIGS. 13A and 13B depict second explanatory diagrams illustrating an example of a calculation of an amount of characteristic change of a part;

FIG. 14 is a first explanatory diagram illustrating an example of a characteristic determination result screen;

FIG. 15 is a second explanatory diagram illustrating an example of a characteristic determination result screen;

FIGS. 16A and 16B depict flowcharts illustrating an example of a procedure of transportation route calculation performed by an information processing device; and

FIG. 17 is a flowchart illustrating an example specific procedure of a characteristic change amount calculation process.

### DESCRIPTION OF EMBODIMENT

At present, it is still difficult to obtain an appropriate transportation route with a change in characteristics of a part due to vibration, temperature, etc., during transportation of the part taken into consideration.

It is preferable to obtain an appropriate transportation route while taking into consideration a change in characteristics of a part that is expected to occur during transportation of the part.

Hereinafter, a transportation route calculation program, a transportation route calculation method, and an information processing device according to embodiment of the present technology will be described in detail with reference to the accompanying drawings.

According to one aspect of the present technology, an appropriate transportation route may be obtained with a change in characteristics (hereinafter referred to also as a “characteristic change” as appropriate) that is expected to occur during transportation of a part taken into consideration.

### Embodiment

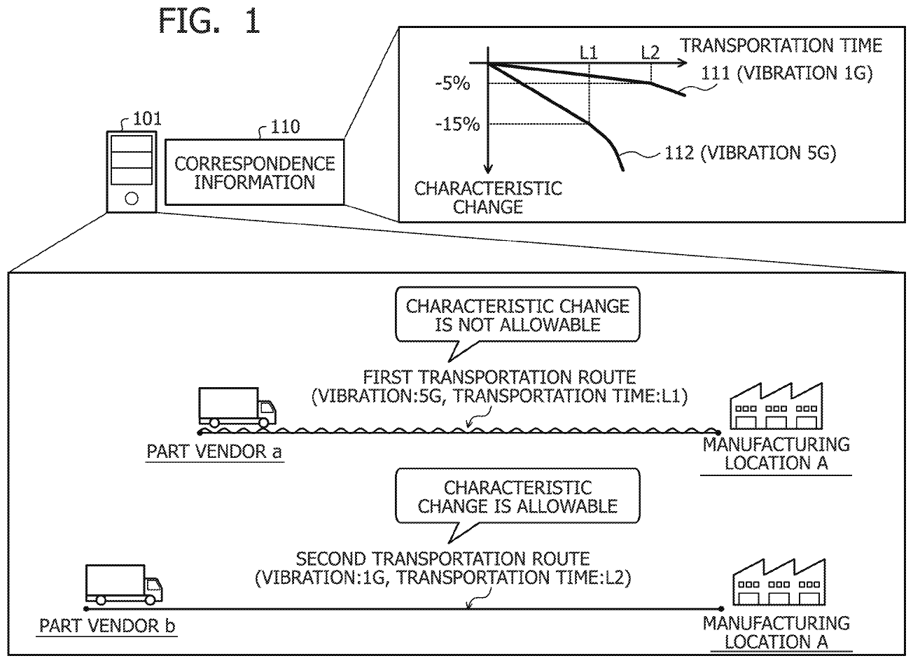

FIG. 1 is an explanatory diagram illustrating an example of a transportation route calculation method according to an embodiment of the present technology. In FIG. 1, an information processing device 101 is a computer that outputs information for identifying a transportation route of a part used to manufacture a device to be manufactured.

The device to be manufactured is a product manufactured by assembling a plurality of parts, and is, for example, an electronic device, an automobile, or the like. The parts are electronic components, such as oscillators, capacitors, and the like. The transportation route of the part is a route from a place at which the part is procured to a place at which the device to be manufactured is manufactured. The place at which the part is procured is, for example, a part production place (e.g., a factory) of a part vendor.

It is important to take into consideration effects of vibration, temperature, etc., during transportation on the performance and quality of the part when deciding on the transportation route of the part. For example, electronic components may change in characteristics due to vibration, temperature, etc., during transportation. For example, in the case where the part is an oscillator, vibration, temperature, etc., during transportation may cause a change in frequency (i.e., output frequency). In the case where the part is a capacitor, for example, vibration, temperature, etc., during transportation may cause changes in capacitance, insulation resistance, leakage current, and so on.

For example, even if no characteristic change is found when the part is shipped from a part vendor, a characteristic change may be found after the part transported reaches the place at which the device is manufactured. A large characteristic change of the part may result in insufficient performance or quality of the part. Therefore, it is important to determine whether or not a characteristic change of the part that is expected to occur while the part passes through a transportation route is allowable when deciding on the transportation route of the part.

An effect of transportation on a product (or a device) may be investigated in advance, and when a significant effect is expected, the part may be packed using a special method, for example, to ensure sufficient quality of the product. In this case, however, a need for an operation of packing the part using the special method, for example, may lead to an increase in cost required for the transportation of the part.

Thus, a transportation route calculation method according to the present embodiment, which may be employed to obtain an appropriate transportation route while taking into consideration a change (e.g., a frequency change, a capacitance change, etc.) in characteristics of a part that is expected to occur during transportation of the part due to vibration, temperature, etc., will be described below. Hereinafter, an example of processing performed by the information processing device 101 will be described.

(1) The information processing device 101 refers to correspondence information 110, and determines whether or not a characteristic change of a part corresponding to a transportation time required when a first transportation route is passed through exceeds a threshold value based on conditions when the first transportation route is used for transportation. The correspondence information 110 is information that indicates relationships between conditions when parts are transported, transportation times of the parts, and characteristic changes of the parts.

The conditions when the parts are transported are expressed by elements that may affect the performance or quality of the parts, such as the magnitude of vibration, temperature, humidity, atmospheric pressure, and so on, during the transportation of the parts. The transportation times of the parts are times required for the transportation of the parts. The characteristic changes of the parts are changes in characteristics that may affect the performance or quality of the parts.

In the case where the part is an oscillator, for example, a characteristic change corresponds to a change in frequency (i.e., output frequency). In the case where the part is a capacitor, for example, a characteristic change corresponds to a change in capacitance, insulation resistance, leakage current, or the like. In the case where the part is an integrated circuit (IC) or a large-scale integrated (LSI) circuit, for example, a part failure may be treated as a characteristic change.

Of parts used to manufacture the device to be manufactured, some are easily affected by vibration, while others are not easily affected by vibration. In addition, of the parts used to manufacture the device to be manufactured, some are easily affected by temperature, while others are not easily affected by temperature. Therefore, the correspondence information 110 may include, for example, information regarding each of the parts used to manufacture the device to be manufactured, the information indicating relationships between conditions when the part is transported, transportation times of the part, and characteristic changes of the part.

A threshold value concerning a characteristic change of a part may be set in any desired manner. For example, when the characteristic change is a “change in frequency,” the threshold value may be an allowable amount of change in frequency from an initial value (i.e., a frequency at the time of shipping). When the characteristic change is a “change in capacitance,” the threshold value may be an allowable amount of change in capacitance from an initial value (i.e., a capacitance at the time of shipping).

In the example of FIG. 1, the correspondence information 110 is assumed to include information indicating relationships between the conditions (vibration: 1 G and 5 G) when a part is transported, the transportation time of the part, and the characteristic change of the part. A graph 111 indicates the characteristic change over time when vibration of 1 G is applied to the part. A graph 112 indicates the characteristic change over time when vibration of 5 G is applied to the part. When the vibration of 5 G is applied, the characteristic change with the transportation time is greater than when the vibration of 1 G is applied.

It is also assumed here that the first transportation route is a route from part vendor a, which is a place at which the part is procured, to manufacturing location A, which is a place at which the device to be manufactured is manufactured (transportation means: road vehicle). It is also assumed that a condition when the first transportation route is used for the transportation is “vibration: 5 G,” and that the transportation time required when the first transportation route is passed through is “transportation time L1.” In this case, the information processing device 101, for example, refers to the correspondence information 110 (e.g., the graph 112), and calculates a characteristic change of the part, “−15%,” corresponding to the transportation time L1 required when the first transportation route is passed through, based on the condition (vibration: 5 G) when the first transportation route is used for the transportation.

The information processing device 101 determines whether or not the calculated characteristic change of the part, “−15%,” exceeds a threshold value. It is assumed here that the threshold value concerning the characteristic change of the part is “±10%.” In this case, the information processing device 101 determines that the calculated characteristic change of the part, “−15%,” exceeds the threshold value.

The information processing device 101 identifies the conditions when the first transportation route is used for the transportation, and the transportation time required when the first transportation route is passed through, by referring to information indicating relationships between transportation routes, transportation times when the respective transportation routes are passed through, and conditions when the respective transportation routes are used for the transportation, for example. Alternatively, the condition when the first transportation route is used for the transportation, and the transportation time required when the first transportation route is passed through, may be specified by an input operation by a user.

(2) When the information processing device 101 has determined that the characteristic change of the part does not exceed the threshold value, the information processing device 101 outputs information for identifying the first transportation route. Meanwhile, when the information processing device 101 has determined that the characteristic change of the part exceeds the threshold value, the information processing device 101 performs the above determination (1), this time with respect to a second transportation route different from the first transportation route.

The second transportation route is a route that is different from the first transportation route in at least one of the places at which the part is procured, the place at which the device to be manufactured is manufactured, and the transportation means, for example. The transportation means is means by which the part is transported, and examples of the transportation means include a road vehicle, a ship, an airplane, and a railway vehicle.

For example, when the characteristic change of the part exceeds the threshold value, the information processing device 101 determines that the characteristic change of the part that is expected to occur when the first transportation route is passed through is not allowable, and performs the above determination (1) with respect to the second transportation route. Meanwhile, when the characteristic change of the part does not exceed the threshold value, the information processing device 101 determines that the characteristic change of the part that is expected to occur when the first transportation route is passed through is allowable.

In the example of FIG. 1, the characteristic change of the part, “−15%,” with respect to the first transportation route exceeds the threshold value, and therefore, the information processing device 101 performs the above determination (1) with respect to the second transportation route. It is assumed here that the second transportation route is a route from part vendor b, which is a place at which the part is procured, to manufacturing location A, which is the place at which the device to be manufactured is manufactured (transportation means: road vehicle). The second transportation route is different from the first transportation route in the place at which the part is procured.

It is assumed here that a condition when the second transportation route is used for the transportation is “vibration: 1 G,” and that the transportation time required when the second transportation route is passed through is “transportation time L2” (L2>L1). In this case, the information processing device 101, for example, refers to the correspondence information 110 (e.g., the graph 111), and calculates a characteristic change of the part, “−5%,” corresponding to the transportation time L2 required when the second transportation route is passed through, based on the condition (vibration: 1 G) when the second transportation route is used for the transportation.

The information processing device 101 determines whether or not the calculated characteristic change of the part, “−5%,” exceeds the threshold value. It is assumed here that the threshold value concerning the characteristic change of the part is “±10%.” Therefore, the information processing device 101 determines that the calculated characteristic change of the part, “−5%,” does not exceed the threshold value.

In this case, the information processing device 101 outputs information for identifying the second transportation route. The information for identifying the second transportation route may be, for example, information indicating a starting place (i.e., part vendor b), a destination (i.e., manufacturing location A), the transportation means (i.e., road vehicle), etc., of the second transportation route.

Thus, when the information processing device 101 is used, an appropriate transportation route may be obtained with a characteristic change of a part that is expected to occur during the transportation of the part due to vibration, temperature, or the like taken into consideration. For example, a transportation route that allows a change of the part in frequency, capacitance, or the like to fall within an allowable range may be obtained with vibration, temperature, and so on during the transportation of the part taken into account.

In the example of FIG. 1, the transportation route (i.e., the second transportation route) that has a longer transportation time than the first transportation route but which allows the characteristic change of the part due to the magnitude of vibration during the transportation of the part to fall within the allowable range may be obtained. Thus, even when the part to be transported is a part that may be easily affected by vibration, it is possible to decide on a transportation route that ensures that the performance and quality of the part will be maintained at required levels.

(Exemplary System Configuration of System 200)

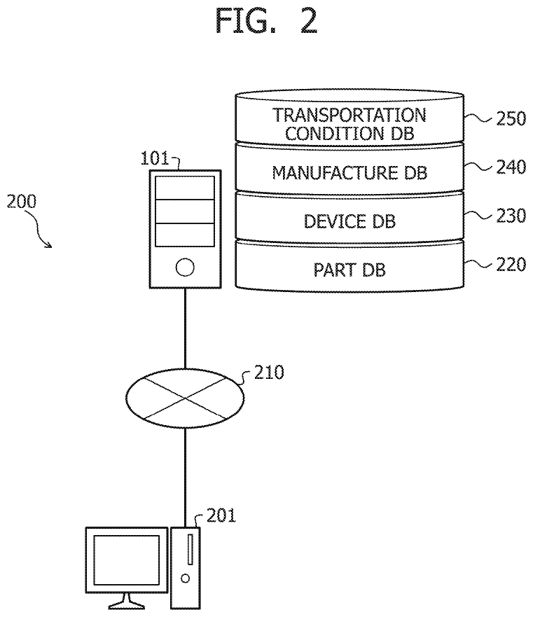

Next, an exemplary system configuration of a system 200 including the information processing device 101 illustrated in FIG. 1 will be described below with respect to FIG. 2. The system 200 is applied to a computer system for providing assistance in deciding on a transportation route of a part, for example.

FIG. 2 is an explanatory diagram illustrating the exemplary system configuration of the system 200. In FIG. 2, the system 200 includes the information processing device 101 and a client device 201. In the system 200, the information processing device 101 and the client device 201 are coupled to each other via a wired or wireless network 210. The network 210 is, for example, a local area network (LAN), a wide area network (WAN), the Internet, or the like.

The information processing device 101 includes a part database (DB) 220, a device DB 230, a manufacture DB 240, and a transportation condition DB 250. The information processing device 101 is, for example, a server. The part DB 220 stores information concerning part vendors, evaluation information concerning characteristic changes of parts, and so on. The correspondence information 110 illustrated in FIG. 1 corresponds to, for example, the evaluation information concerning the characteristic changes of the parts in the part DB 220.

The device DB 230 stores information concerning devices to be manufactured, and information concerning the allowable ranges of characteristic changes of parts used to manufacture the devices to be manufactured. The manufacture DB 240 stores information concerning places at which the devices are manufactured. The transportation condition DB 250 stores, with respect to each of the transportation routes, information concerning conditions when the parts are transported along the transportation route.

Content stored in the part DB 220, the device DB 230, the manufacture DB 240, and the transportation condition DB 250 will be described below with reference to FIGS. 4 to 9.

The client device 201 is a computer used by a user of the system 200. The user of the system 200 is, for example, a person who decides on the transportation route of a part. The client device 201 is, for example, a personal computer (PC), a tablet PC, or the like.

It is assumed in the foregoing description that the information processing device 101 and the client device 201 are provided separately, but it is to be noted that the information processing device 101 and the client device 201 may not necessarily be provided separately. For example, the information processing device 101 may be implemented by the client device 201.

(Exemplary Hardware Configuration of Information Processing Device 101)

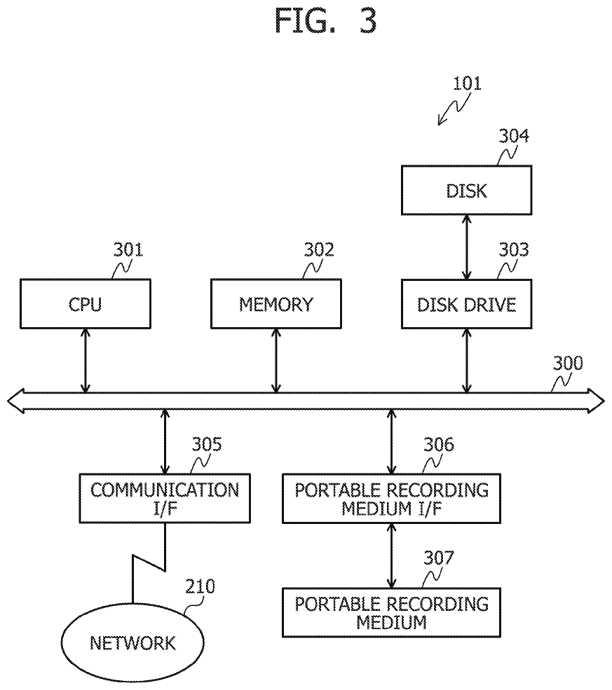

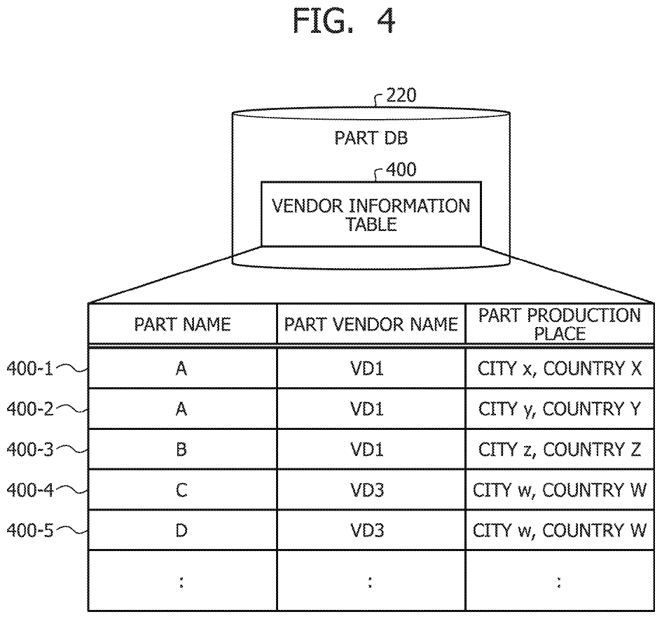

FIG. 3 is a block diagram illustrating an exemplary hardware configuration of the information processing device 101. In FIG. 3, the information processing device 101 includes a central processing unit (CPU) 301, a memory 302, a disk drive 303, a disk 304, a communication interface (I/F) 305, a portable recording medium I/F 306, and a portable recording medium 307. The above components of the information processing device 101 are coupled to one another via a bus 300.

The CPU 301 exercises overall control over the information processing device 101. The CPU 301 may include a plurality of cores. The memory 302 includes, for example, a read-only memory (ROM), a random-access memory (RAM), a flash ROM, and/or the like. For example, the flash ROM stores a program of an operating system (OS), the ROM stores an application program, and the RAM is used as a work area for the CPU 301. The programs stored in the memory 302 are loaded by the CPU 301, causing the CPU 301 to perform a process coded therein.

The disk drive 303 controls reading and writing of data from or to the disk 304 in accordance with control by the CPU 301. The disk 304 stores the data written thereto under control of the disk drive 303. Examples of the disk 304 include a magnetic disk, an optical disk, and so on.

The communication I/F 305 is coupled to the network 210 via a communication channel, and is coupled to an external computer (e.g., the client device 201 illustrated in FIG. 2) via the network 210. The communication I/F 305 serves as an interface between the network 210 and an interior of the information processing device 101, and controls input and output of data from or to the external computer. A modem, a LAN adapter, or the like, for example, may be adopted as the communication I/F 305.

The portable recording medium I/F 306 controls reading and writing of data from or to the portable recording medium 307 in accordance with control by the CPU 301. The portable recording medium 307 stores the data written thereto under control of the portable recording medium I/F 306. Examples of the portable recording medium 307 include a compact disc (CD)-ROM, a digital versatile disk (DVD), and a universal serial bus (USB) memory.

In addition to the above-described components, the information processing device 101 may include, for example, a solid-state drive (SSD), an input device, a display, and/or the like. The information processing device 101 may not include, out of the above-described components, the disk drive 303, the disk 304, the portable recording medium I/F 306, and the portable recording medium 307, for example. The client device 201 illustrated in FIG. 2 may also be implemented by a hardware configuration similar to that of the information processing device 101. Note that the client device 201 includes an input device and a display in addition to the above-described components.

(Contents Stored in Part DB 220)

Next, the contents stored in the part DB 220 of the information processing device 101 will be described below. First, a vendor information table 400 in the part DB 220 will be described below with respect to FIG. 4.

FIG. 4 is an explanatory diagram illustrating a specific example of the vendor information table 400 in the part DB 220. In FIG. 4, the vendor information table 400 has fields of part name, part vendor name, and part production place, and stores records of vendor information (e.g., vendor information 400-1 to 400-5) with information set in each field.

A part name is a name of a part. A part vendor name is a name of a part vendor from which a part is procured. A part production place indicates a place of a factory of a part vendor. For example, the vendor information 400-1 indicates part vendor name “VD1” and part production place “City x, Country X” of a part vendor from which a part with part name “A” is procured.

In the following description, a part with part name “#” may be referred to as “part #,” and a part vendor with part vendor name “VD #” may be referred to as “part vendor VD #.”

Next, the evaluation information concerning the characteristic changes of the parts in the part DB 220 will be described below.

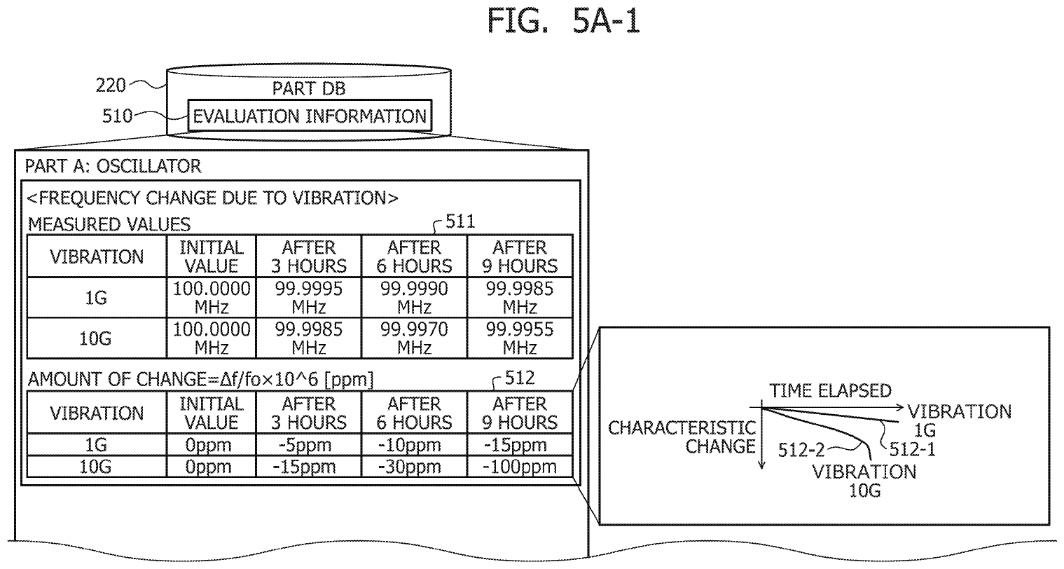

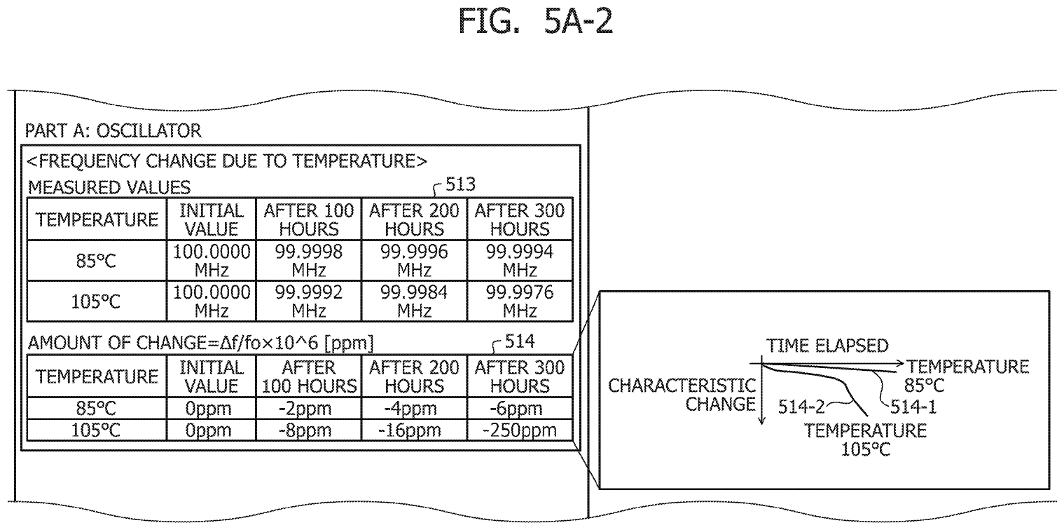

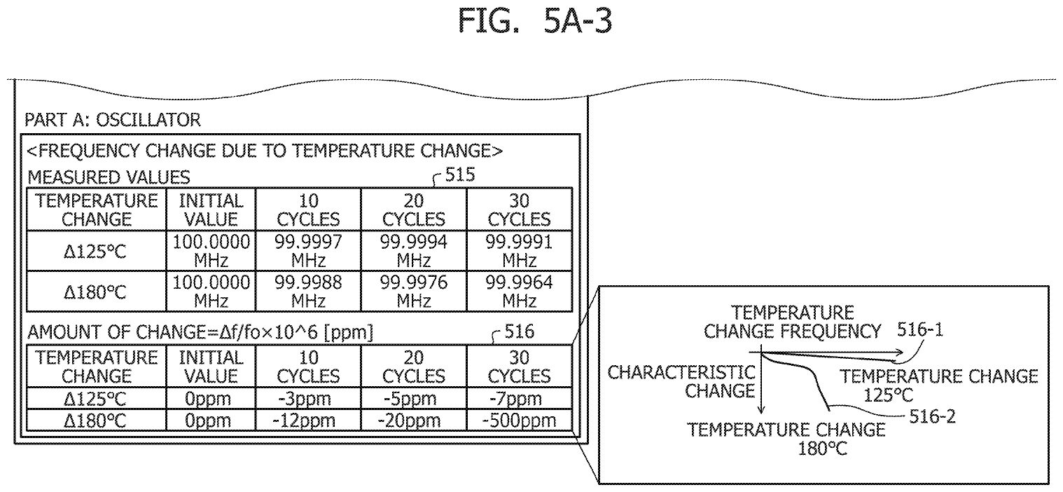

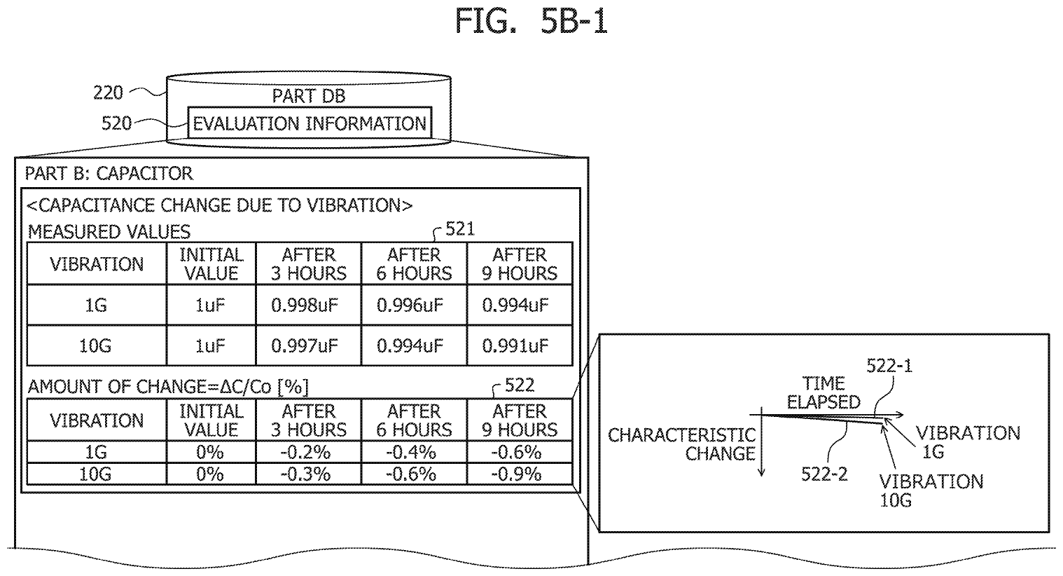

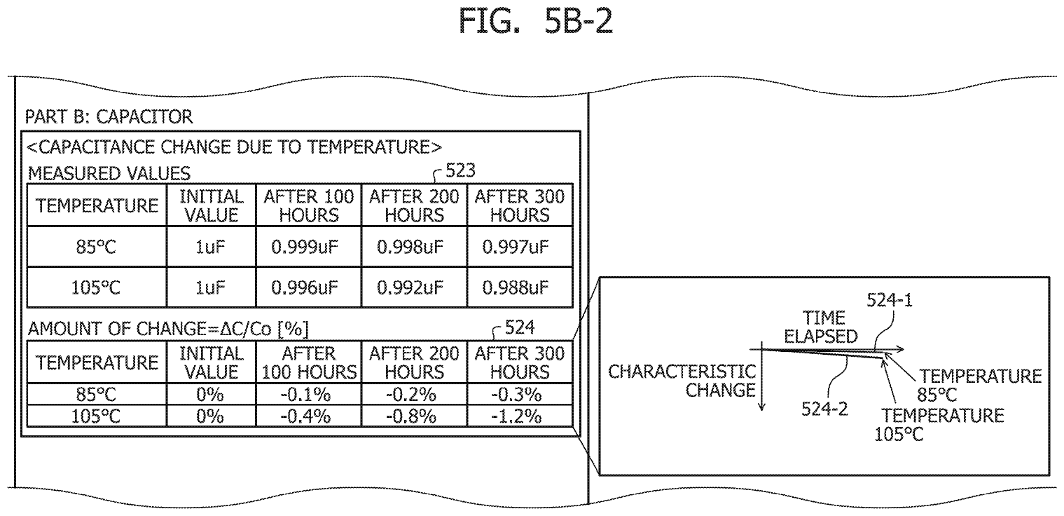

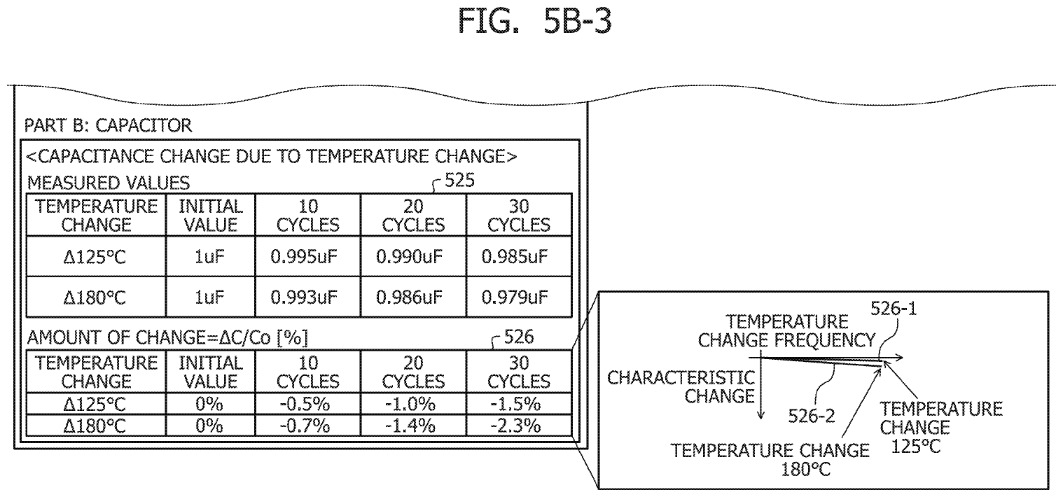

FIGS. 5A-1 to 5A-3 depict first explanatory diagrams illustrating a specific example of the evaluation information in the part DB 220. In FIG. 5A-1, evaluation information 510 is information concerning characteristic changes of part A. It is assumed here that part A is an oscillator, and that the characteristic changes of part A are “changes in frequency (i.e., output frequency) of part A.”

The evaluation information 510 includes measured value information 511 and characteristic change information 512 concerning a case where vibration of 1 G or 10 G is applied to part A. The measured value information 511 indicates the change over time in frequency (measured value) when the vibration of 1 G or 10 G is applied to part A. For example, if three hours elapse after a start of the application of the vibration of 1 G to part A, the frequency changes from an initial value, “100.0000 MHz,” to “99.9995 MHz.”

The characteristic change information 512 indicates the change over time in amount of change in frequency when the vibration of 1 G or 10 G is applied to part A. The amount of change in frequency is expressed as “Δf/f₀×10\hat{ }6 [ppm].” Here, f₀ denotes an initial value, and Δf denotes a difference from the initial value. For example, if three hours elapse after the start of the application of the vibration of 1 G to part A, the amount of change in frequency changes from the initial value, “0 ppm,” to “−5 ppm.”

Graphs 512-1 and 512-2 represent, in graph form, the changes over time in amount of change in frequency indicated by the characteristic change information 512.

The evaluation information 510 also includes measured value information 513 and characteristic change information 514 concerning a case where the temperature of surroundings of part A is 85° C. or 105° C. The measured value information 513 indicates the change over time in frequency (measured value) when the temperature of the surroundings of part A is 85° C. or 105° C. For example, if 100 hours elapse with the temperature of the surroundings of part A being 85° C., the frequency changes from the initial value, “100.0000 MHz,” to “99.9998 MHz.”

The characteristic change information 514 indicates the change over time in amount of change in frequency when the temperature of the surroundings of part A is 85° C. or 105° C. For example, if 100 hours elapse with the temperature of the surroundings of part A being 85° C., the amount of change in frequency changes from the initial value, “0 ppm,” to “−2 ppm.”

Graphs 514-1 and 514-2 represent, in graph form, the changes over time in amount of change in frequency indicated by the characteristic change information 514.

The evaluation information 510 also includes measured value information 515 and characteristic change information 516 concerning a case where a temperature change of Δ125° C. or Δ180° C. has occurred in the surroundings of part A. The measured value information 515 indicates frequencies (measured values) corresponding to several numbers of times (temperature change frequencies) the temperature change of Δ125° C. or Δ180° C. has occurred in the surroundings of part A. For example, if the temperature change of Δ125° C. occurs 10 times in the surroundings of part A, the frequency changes from the initial value, “100.0000 MHz,” to “99.9997 MHz.”

The characteristic change information 516 indicates amounts of change in frequency corresponding to the several numbers of times (temperature change frequencies) the temperature change of Δ125° C. or Δ180° C. has occurred in the surroundings of part A. For example, if the temperature change of Δ125° C. occurs 10 times in the surroundings of part A, the amount of change in frequency changes from the initial value, “0 ppm,” to “−3 ppm.”

Graphs 516-1 and 516-2 represent, in graph form, how the amounts of change in frequency indicated by the characteristic change information 516 vary in accordance with the temperature change frequency.

FIGS. 5B-1 to 5B-3 depict second explanatory diagrams illustrating a specific example of the evaluation information in the part DB 220. In FIG. 5B-1, evaluation information 520 is information concerning characteristic changes of part B. It is assumed here that part B is a capacitor, and that the characteristic changes of part B are “changes in capacitance of part B.”

The evaluation information 520 includes measured value information 521 and characteristic change information 522 concerning a case where vibration of 1 G or 10 G is applied to part B. The measured value information 521 indicates the change over time in capacitance when the vibration of 1 G or 10 G is applied to part B. For example, if three hours elapse after a start of the application of the vibration of 1 G to part B, the capacitance changes from an initial value, “1 uF,” to “0.998 uF.”

The characteristic change information 522 indicates the change over time in amount of change in capacitance when the vibration of 1 G or 10 G is applied to part B. The amount of change in capacitance is expressed as “ΔC/C₀ [%].” Here, C₀ denotes an initial value, and ΔC denotes a difference from the initial value. For example, if three hours elapse after the start of the application of the vibration of 1 G to part B, the amount of change in capacitance changes from the initial value, “0%,” to “−0.2%.”

Graphs 522-1 and 522-2 represent, in graph form, the changes over time in amount of change in capacitance indicated by the characteristic change information 522.

The evaluation information 520 also includes measured value information 523 and characteristic change information 524 concerning a case where the temperature of surroundings of part B is 85° C. or 105° C. The measured value information 523 indicates the change over time in capacitance when the temperature of the surroundings of part B is 85° C. or 105° C. For example, if 100 hours elapse with the temperature of the surroundings of part B being 85° C., the capacitance changes from the initial value, “1 uF,” to “0.999 uF.”

The characteristic change information 524 indicates the change over time in amount of change in capacitance when the temperature of the surroundings of part B is 85° C. or 105° C. For example, if 100 hours elapse with the temperature of the surroundings of part B being 85° C., the amount of change in capacitance changes from the initial value, “0%,” to “−0.1%.”

Graphs 524-1 and 524-2 represent, in graph form, the changes over time in amount of change in capacitance indicated by the characteristic change information 524.

The evaluation information 510 also includes measured value information 525 and characteristic change information 526 concerning a case where a temperature change of Δ125° C. or Δ180° C. has occurred in the surroundings of part B. The measured value information 525 indicates capacitance values corresponding to several numbers of times (temperature change frequencies) the temperature change of Δ125° C. or Δ180° C. has occurred in the surroundings of part B. For example, if the temperature change of Δ125° C. occurs 10 times in the surroundings of part B, the capacitance changes from the initial value, “1 uF,” to “0.995 uF.”

The characteristic change information 526 indicates amounts of change in capacitance corresponding to the several numbers of times (temperature change frequencies) the temperature change of Δ125° C. or Δ180° C. has occurred in the surroundings of part B. For example, if the temperature change of Δ125° C. occurs 10 times in the surroundings of part B, the amount of change in capacitance changes from the initial value, “0%,” to “−0.5%.”

Graphs 526-1 and 526-2 represent, in graph form, how the amounts of change in capacitance indicated by the characteristic change information 526 vary in accordance with the temperature change frequency.

(Contents Stored in Device DB 230)

Next, the contents stored in the device DB 230 of the information processing device 101 will be described below. First, a part list 600 in the device DB 230 will be described with reference to FIG. 6.

FIG. 6 is an explanatory diagram illustrating a specific example of the part list 600 in the device DB 230. In FIG. 6, the part list 600 has fields of device name, part name, and number, and stores records of device information (e.g., device information 600-1) with information set in each field.

A device name is a name of a device to be manufactured. A part name is a name of a part used to manufacture a device. A number is the number of parts required to manufacture a device. For example, the device information 600-1 indicates that 100 parts A, 50 parts B, 70 parts G, and 100 parts K are required to manufacture a device with device name “AP1.”

In the following description, a device with device name “AP #” may be referred to as “device AP #.”

Next, an allowable range table 700 in the device DB 230 will be described below.

FIG. 7 is an explanatory diagram illustrating a specific example of the allowable range table 700 in the device DB 230. In FIG. 7, the allowable range table 700 has fields of device name, part name, characteristic, and allowable range, and stores records of allowable range information (e.g., allowable range information 700-1 to 700-4) with information set in each field.

A device name is a name of a device to be manufactured. A part name is a name of a part used to manufacture a device. A characteristic is a characteristic of a part. An allowable range is an allowable range concerning a characteristic change of a part. The allowable range is determined, for example, by a designer of a circuit in accordance with requirements of the circuit. For example, the allowable range information 700-1 indicates that the allowable range of the characteristic change in the characteristic “frequency” is “±50 ppm” with respect to part A to be included in device AP1.

(Contents Stored in Manufacture DB 240)

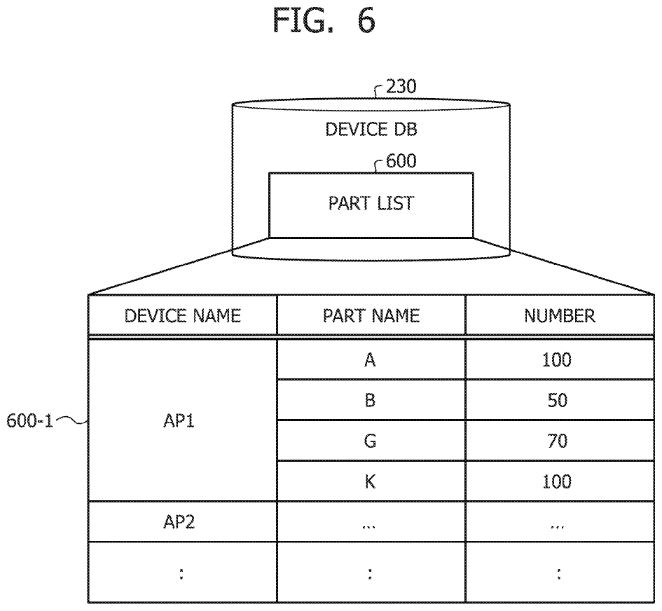

Next, the contents stored in the manufacture DB 240 of the information processing device 101 will be described below. Here, a manufacturing location table 800 in the manufacture DB 240 will be described with reference to FIG. 8.

FIG. 8 is an explanatory diagram illustrating a specific example of the manufacturing location table 800 in the manufacture DB 240. In FIG. 8, the manufacturing location table 800 has fields of device name, location name, and place, and stores records of manufacturing location information (e.g., manufacturing location information 800-1 to 800-3) with information set in each field.

A device name is a name of a device to be manufactured. A location name is a name of a manufacturing location at which a device is manufactured. A place indicates the place of a manufacturing location. For example, the manufacturing location information 800-1 indicates location name “XY” and place “City I, Country XY” of a manufacturing location at which device AP1 is manufactured.

(Contents Stored in Transportation Condition DB 250)

Next, the contents stored in the transportation condition DB 250 of the information processing device 101 will be described below. The various databases (DBs) 220, 230, 240, and 250 of the information processing device 101 are implemented by a storage device, such as the memory 302, the disk 304, or the like, of the information processing device 101 illustrated in FIG. 3.

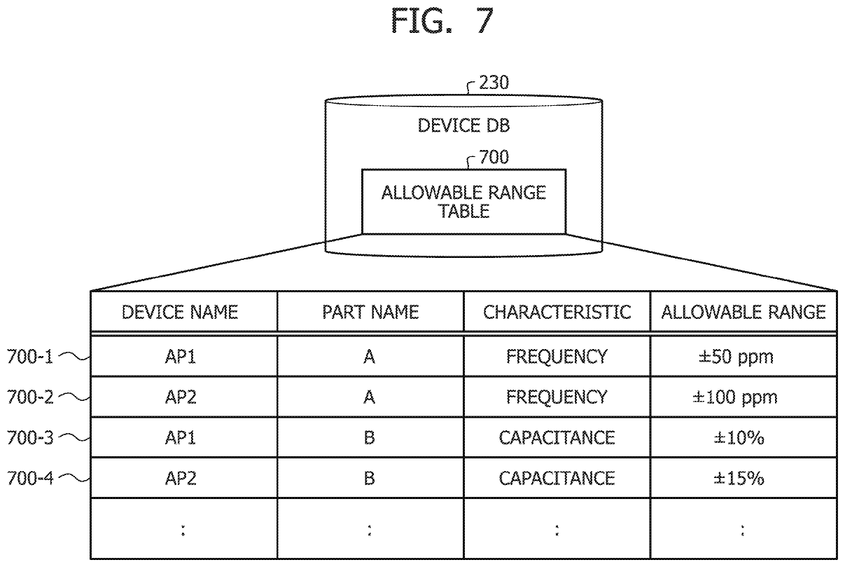

FIG. 9 is an explanatory diagram illustrating an example of the contents stored in the transportation condition DB 250. In FIG. 9, the transportation condition DB 250 has fields of starting place, passed-through place, destination, transportation means, time, vibration, temperature, temperature change, and transportation cost. Records of transportation conditions (e.g., transportation conditions 900-1 to 900-3) are stored therein with information set in each field.

A starting place is a starting point of a transportation route. A passed-through place is a place that is passed through on the way from a starting place to a destination. The passed-through place may not necessarily be set. A destination is an end point of a transportation route. Transportation means is means by which a part is transported. The road vehicle, the ship, the airplane, the railway vehicle, or the like, for example, is set as the transportation means.

A time is a transportation time (unit: h) required when a transportation route is passed through. The vibration is an indicator of an environment in which a transportation route is used for transportation, and indicates the magnitude of vibration that is expected to occur during transportation of a part. The average magnitude of vibrations that are expected to occur during the transportation of a part, for example, is set as the magnitude of vibration. The temperature is an indicator of an environment in which a transportation route is used for transportation, and indicates a temperature during transportation of a part. The average temperature during the transportation of a part, for example, is set as the temperature. Note, however, that the highest temperature or the lowest temperature during the transportation of a part may alternatively be set as the temperature. The temperature change is an indicator of an environment in which a transportation route is used for transportation, and indicates the number of times a specified temperature change is expected to occur during transportation of a part.

The transportation cost indicates a transportation cost when a transportation route is used for transportation. Here, the transportation cost corresponds to a cost required when any one part is transported. Note, however, that different transportation costs may be set for different parts. The transportation cost is set with the transportation means, the distance, a duty (or lack of a duty), and so on taken into account, for example. Note that the transportation cost does not include a cost required for packing of a part.

For example, the transportation conditions 900-1 indicate “road vehicle” as the transportation means, “2 h” as the time, “5 G” as the vibration, “45° C.” as the temperature, “Δ10° C., 5 cycles” as the temperature change, and “c1” as the transportation cost, with respect to a transportation route from “City x, Country X” as the starting place to “City p, Country X” as the destination through “City n, Country X” as the passed-through place.

The transportation conditions in the transportation condition DB 250 are created by, for example, an administrator of the system 200. In more detail, each set of transportation conditions may be created, for example, based on results of measuring vibrations, temperatures, changes in temperature, and so on when a part was actually transported through the corresponding transportation route. In addition, each set of transportation conditions may be created as appropriate with the transportation means, pavement conditions, ocean current conditions, and/or the like of the corresponding transportation route taken into account.

(Exemplary Functional Structure of Information Processing Device 101)

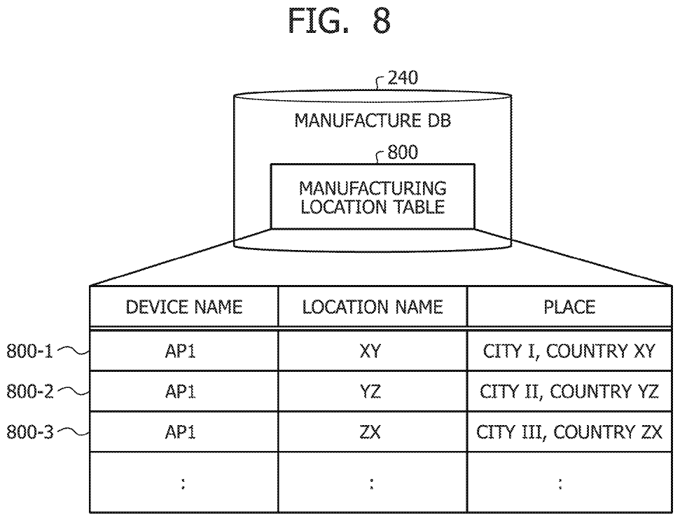

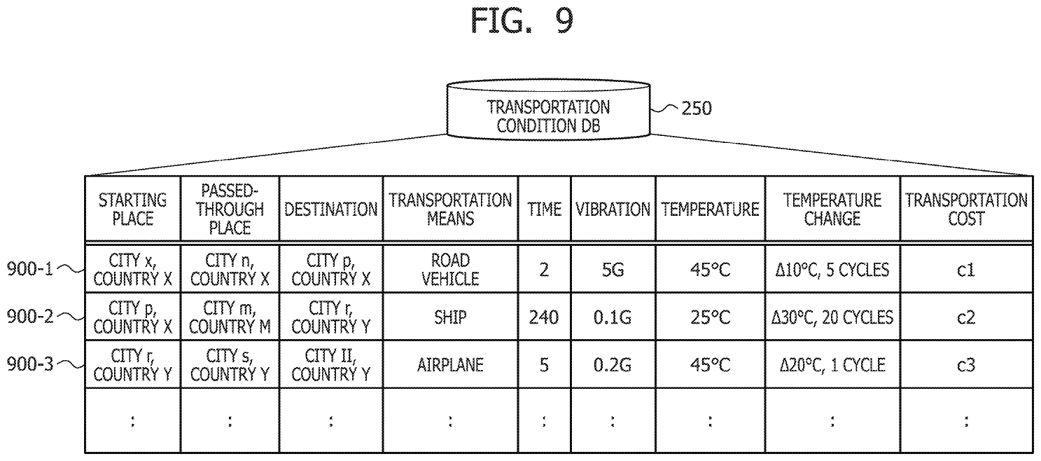

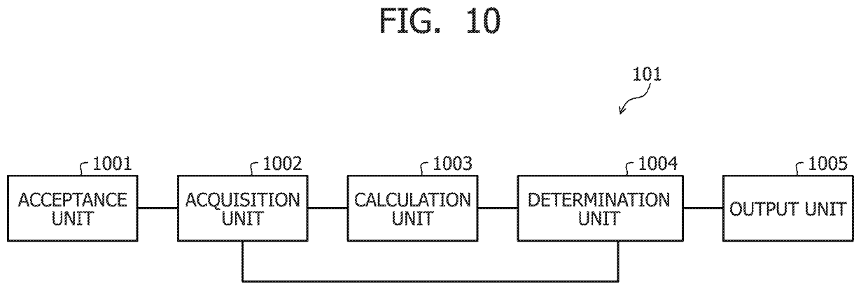

FIG. 10 is a block diagram illustrating an exemplary functional structure of the information processing device 101. In FIG. 10, the information processing device 101 includes an acceptance unit 1001, an acquisition unit 1002, a calculation unit 1003, a determination unit 1004, and an output unit 1005. The acceptance unit 1001, the acquisition unit 1002, the calculation unit 1003, the determination unit 1004, and the output unit 1005 correspond to functions of a control unit, and, for example, the functions thereof are implemented by the CPU 301 executing a program stored in a storage device, such as the memory 302, the disk 304, or the portable recording medium 307 illustrated in FIG. 3, or through the communication I/F 305. A result of processing by each functional unit is stored in a storage device such as, the memory 302, the disk 304, or the like.

The acceptance unit 1001 accepts a specification of the device to be manufactured. For example, the acceptance unit 1001 may accept the specification of the device to be manufactured by accepting a part list of the device to be manufactured from the client device 201 illustrated in FIG. 2. The accepted part list is, for example, registered in the part list 600 illustrated in FIG. 6.

Note that the part list of the device to be manufactured may be registered in advance in the part list 600. In this case, the acceptance unit 1001 may accept the specification of the device to be manufactured by, for example, accepting the device name of the device to be manufactured from the client device 201.

The acceptance unit 1001 accepts a specification of a part to be transported among the parts used to manufacture the device to be manufactured. For example, the acceptance unit 1001 may accept the specification of the part to be transported by accepting a part name of the device to be manufactured from the client device 201.

The acceptance unit 1001 accepts a specification of a manufacturing location at which the device to be manufactured is manufactured. For example, the acceptance unit 1001 may accept the specification of the manufacturing location by accepting, from the client device 201, the location name of the manufacturing location at which the device to be manufactured is manufactured.

The acquisition unit 1002 acquires a transportation route of a part used to manufacture the device to be manufactured. Here, the part for which the transportation route is acquired is, for example, the specified part among the parts used to manufacture the device to be manufactured. Note that the transportation routes may alternatively be acquired for all the parts used to manufacture the device to be manufactured.

A transportation route of a part is a route from a place at which the part is procured to a place at which the device to be manufactured is manufactured. The place at which the part is procured is, for example, a part production place (e.g., a factory) of a part vendor. When there are a plurality of part vendors that produce a certain part, any of part production places of the respective part vendors may be the place at which that part is procured. A single part vendor may have a plurality of part production places at which the same parts are produced.

The place at which the device to be manufactured is manufactured may be, for example, the specified manufacturing location, or any manufacturing location corresponding to the specified device to be manufactured. The manufacturing location corresponding to the device to be manufactured may be identified, for example, from the manufacturing location table 800 in the manufacture DB 240 illustrated in FIG. 8.

For example, the acquisition unit 1002 may refer to the transportation condition DB 250 illustrated in FIG. 9, and search for a transportation route from the part production place of the part vendor to the manufacturing location corresponding to the device to be manufactured. The part production place of the part vendor may be identified, for example, from the vendor information table 400 in the part DB 220 illustrated in FIG. 4. For example, there are “City x, Country X” and “City y, Country Y” as part production places of part vendor VD1 for producing part A.

To describe in more detail, the acquisition unit 1002 may, for example, refer to the transportation condition DB 250, and search for and discover top N transportation routes that have the lowest total transportation costs among the transportation routes from the part production places of each part vendor to the manufacturing location. Suppose, for example, that the part production place of the part vendor is “City x, Country X” and the manufacturing location of the device to be manufactured is “City II, Country Y.” In this case, a transportation route identified from the transportation conditions 900-1 to 900-3, for example, is discovered. This transportation route is a route that passes through route 1, “City x, Country X=>City n, Country X=>City p, Country X,” route 2, “City p, Country X=>City m, Country M=>City r, Country Y,” and route 3 “City r, Country Y=>City s, Country Y=>City II, Country Y.” The transportation cost thereof amounts to “c1+c2+c3.”

Note that the transportation routes from the part production places of the part vendors to the manufacturing locations may be searched for and discovered in advance, and be stored in a storage device, such as the memory 302, the disk 304, or the like. In this case, the acquisition unit 1002 may extract, from the search results discovered in advance, the transportation route from the part production place of the part vendor to the manufacturing location. Also note that the acquisition unit 1002 may access an external computer for providing a route search service, and acquire the transportation route from the part production place of the part vendor to the manufacturing location, for example.

The calculation unit 1003 refers to the information indicating the relationships between the conditions when the part is transported, the transportation times of the part, and the characteristic changes of the part, and calculates the characteristic change of the part corresponding to the transportation time required when the first transportation route is passed through, based on the conditions when the first transportation route is used for the transportation. Here, the first transportation route is one of the transportation routes acquired by the acquisition unit 1002 with respect to the part used to manufacture the device to be manufactured. For example, the first transportation route may be the transportation route that has the lowest total transportation cost out of the top N transportation routes that have the lowest total transportation costs.

The conditions when the part is transported are expressed by, for example, the magnitude of vibration, temperature, humidity, atmospheric pressure, and so on, during the transportation of the part. The transportation time of the part is a time required for the transportation of the part. The characteristic change of the part is a change in characteristics that affects the performance or quality of the part.

The information indicating the relationships between the conditions when the part is transported, the transportation time of the part, and the characteristic change of the part corresponds to, for example, the characteristic change information 512 and 514 of the evaluation information 510 illustrated in FIGS. 5A-1 and 5A-2, and the characteristic change information 522 and 524 of the evaluation information 520 illustrated in FIGS. 5B-1 and 5B-2. In the following description, the conditions when the part is transported may be referred to as “transportation conditions.”

In addition, the calculation unit 1003 may refer to information indicating the relationships between characteristic changes of the part and the numbers of times a temperature change occurs during the transportation of the part, and calculate a characteristic change of the part corresponding to the number of times a temperature change occurs when the first transportation route is passed through. Here, the temperature change that occurs during the transportation of the part is, for example, a temperature change that is expected to occur due to a change in weather, climate, or the like during the transportation of the part.

The number of times a temperature change occurs during the transportation of the part is one of the conditions (i.e., the transportation conditions) when the part is transported. Some parts are easily affected by temperature change, and tend to experience greater characteristic changes as the number of times of temperature changes increases. Accordingly, the calculation unit 1003 may calculate the characteristic change of the part in accordance with the number of times a temperature change of ΔT occurs when the first transportation route is passed through. The value of ΔT may be set in any desired manner.

The information indicating the relationships between the characteristic changes of the part and the temperature changes during the transportation of the part corresponds to, for example, the characteristic change information 516 of the evaluation information 510 illustrated in FIG. 5A-3, and the characteristic change information 526 of the evaluation information 520 illustrated in FIG. 5B-3.

For example, the calculation unit 1003 selects one of the transportation routes (i.e., the first transportation route) among the acquired transportation routes, and determines the selected transportation route (i.e., the first transportation route) to be a candidate transportation route. The calculation unit 1003 refers to the transportation condition DB 250, and identifies the transportation time required when the candidate transportation route is passed through, and the transportation conditions when the candidate transportation route is used for the transportation, for example. The transportation conditions are, for example, the magnitude of vibration, the temperature, the number of times of temperature changes, and so on.

The calculation unit 1003 acquires, from the part DB 220, the evaluation information (e.g., the evaluation information 510 or 520) regarding the specified part. In the case of part A, for example, the calculation unit 1003 acquires the evaluation information 510 from the part DB 220. Referring to the acquired evaluation information regarding the part, the calculation unit 1003 calculates the amount of characteristic change of the part corresponding to the transportation time or the number of times of temperature changes when the identified candidate transportation route is passed through, based on the transportation conditions when the identified candidate transportation route is used for the transportation.

To describe in more detail, the calculation unit 1003 divides the candidate transportation route into a plurality of transportation stages based on the transportation conditions when the candidate transportation route is used for the transportation, for example. The transportation stages are obtained by dividing the candidate transportation route into sections each having the same transportation conditions. For example, along the candidate transportation route, a change in transportation stage occurs at a point at which the transportation conditions change. In the case where the transportation conditions remain the same all the way along the candidate transportation route when the candidate transportation route is used for the transportation, the candidate transportation route has only one transportation stage. The transportation conditions along the candidate transportation route may be identified from the transportation condition DB 250, for example.

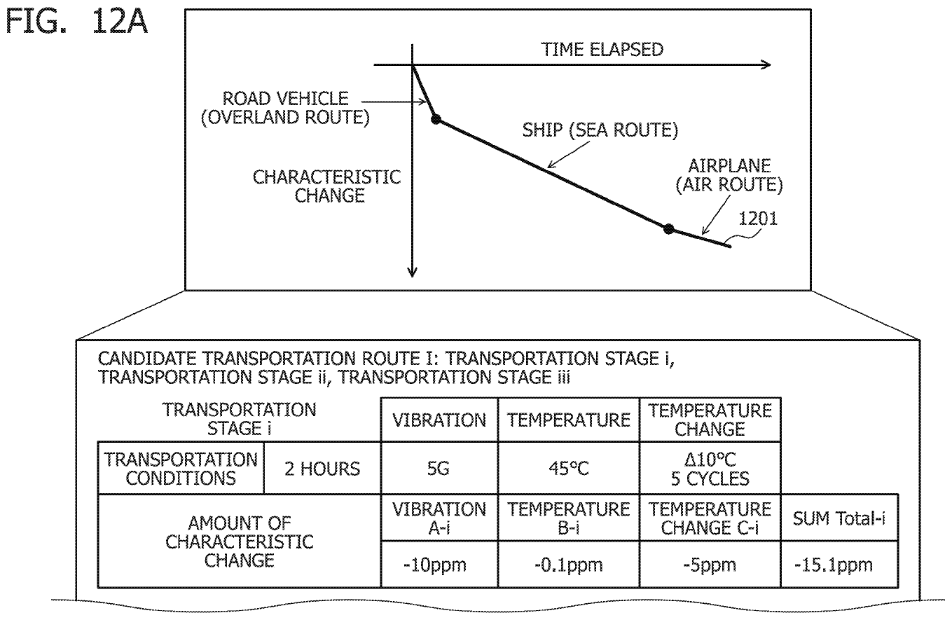

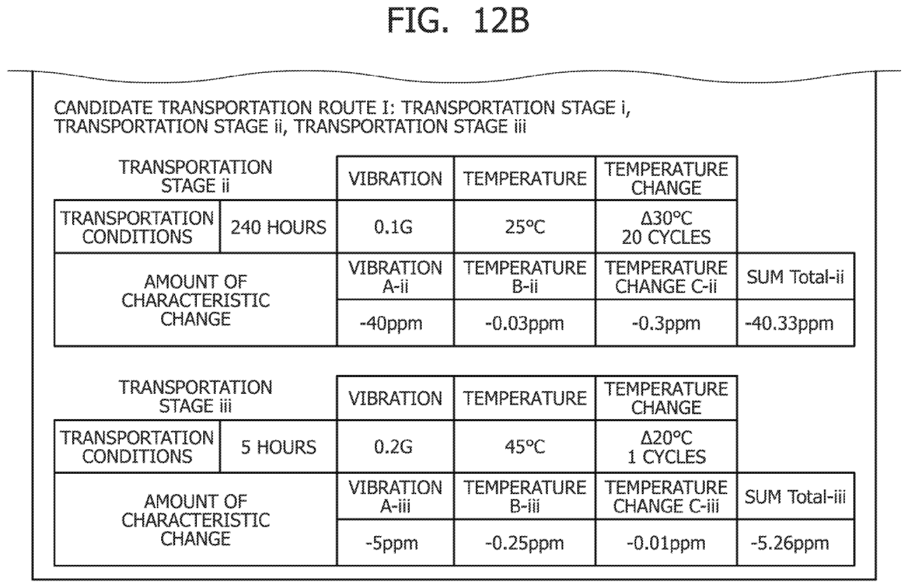

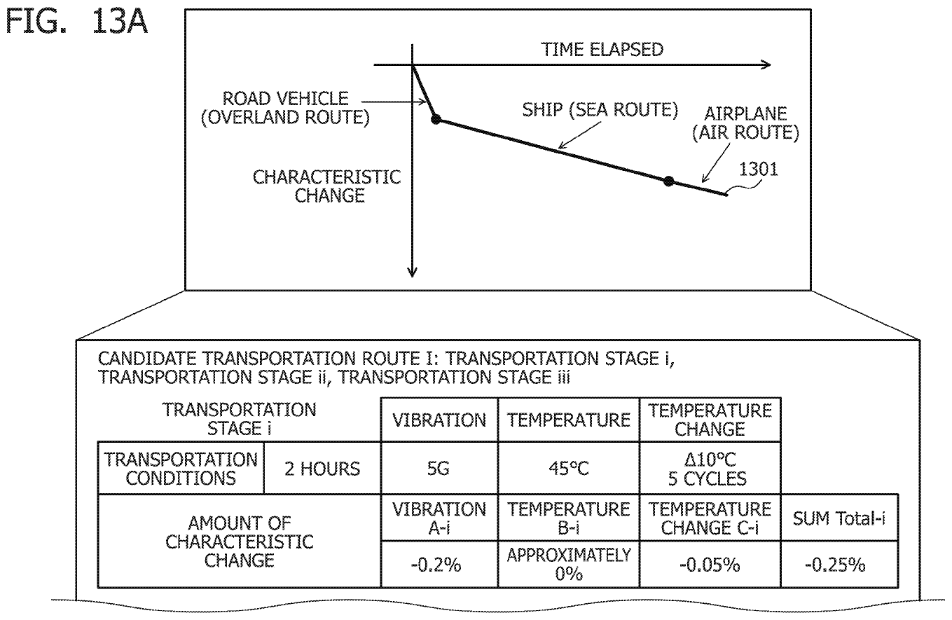

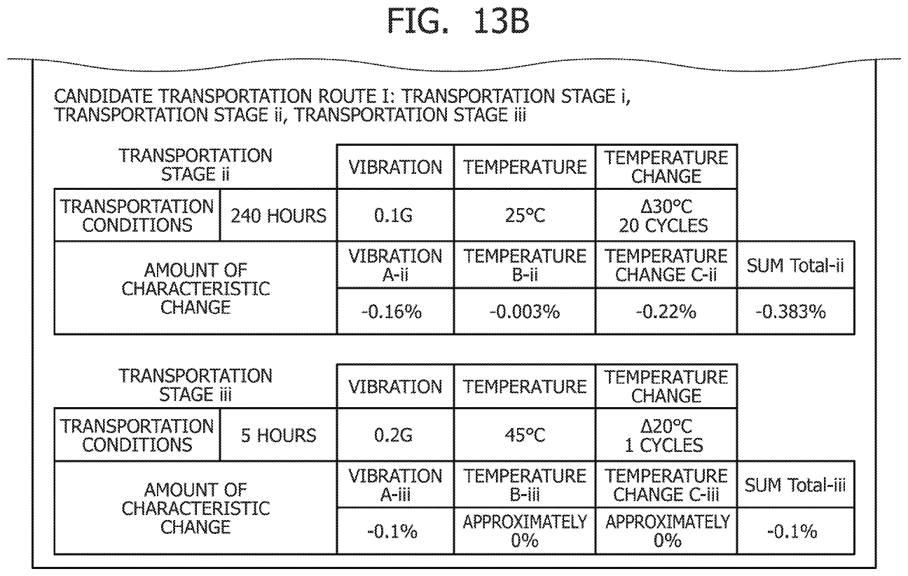

The calculation unit 1003 calculates the amount of characteristic change of the part with respect to each of the divided transportation stages. For example, the calculation unit 1003 refers to the transportation condition DB 250, and identifies, with respect to each transportation stage, the transportation time required when the transportation stage is passed through, and the transportation conditions when the transportation stage is used for the transportation. The calculation unit 1003 calculates, with respect to each transportation stage, the amount of characteristic change of the part corresponding to the transportation time and the temperature change frequency when the identified transportation stage is passed through, based on the conditions when the identified transportation stage is used for the transportation. The calculation unit 1003 calculates the amount of characteristic change of the part with respect to the candidate transportation route based on the amounts of characteristic change of the part calculated with respect to the respective transportation stages. Examples of calculations of the amount of characteristic change of a part with respect to the candidate transportation route will be described below with reference to FIGS. 12A to 13B.

However, the transportation conditions in the evaluation information in the part DB 220 may be different from the transportation conditions when the candidate transportation route (or the transportation stages) is used for the transportation. In this case, the calculation unit 1003 may calculate an approximation of the characteristic change of the part using an acceleration formula, for example. Examples of acceleration formulas include an acceleration formula based on the 10° C. doubling rule according to the Arrhenius law in the case of the temperature, and an acceleration formula based on a Coffin-Manson model in the case of the temperature change.

Here, an example of a calculation of an approximation of the characteristic change of the part will be described below.

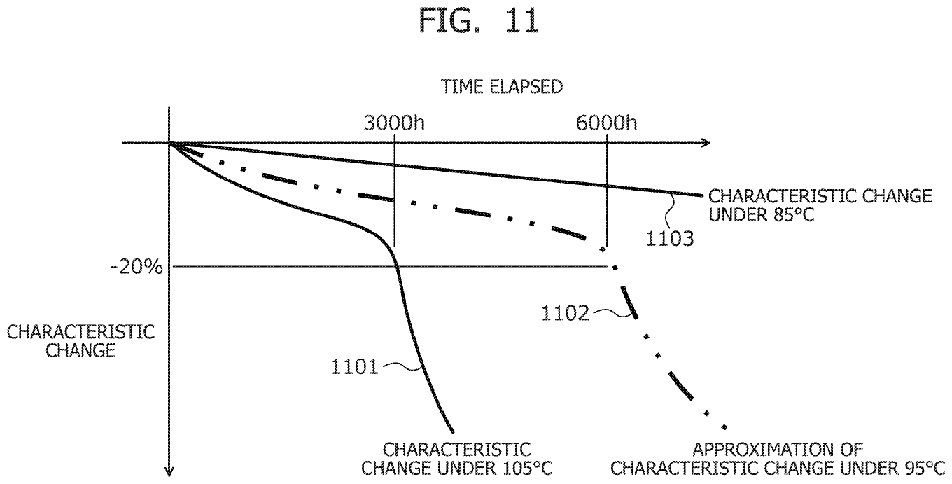

FIG. 11 is an explanatory diagram illustrating the example of the calculation of the approximation of the characteristic change. Here, the temperature is adopted as an example of the transportation conditions, and a case where the transportation condition (105° C.) in the evaluation information in the part DB 220 is different from the transportation condition (95° C.) when the candidate transportation route is used for the transportation is assumed.

It is also assumed that an acceleration formula based on the 10° C. doubling rule as given below as equation (1) is used as an acceleration formula for the characteristic change due to the temperature. In the acceleration formula below, T₀ represents the transportation condition in the evaluation information in the part DB 220. T represents the transportation condition when the candidate transportation route is used for the transportation. L₀ represents the test time under a temperature of T₀. L represents the transportation time under a temperature of T.

L=L₀×2\hat{ }((T₀−T)/10) (1)

In FIG. 11, a graph 1101 represents a characteristic change when the temperature of the part is 105° C. The above equation (1) gives a graph 1102 as an approximation of the graph 1101. In comparison with the graph 1101, which represents the characteristic change under a temperature of 105° C. and indicates a change of −20% in 3000 hours, the approximate graph 1102, which represents the characteristic change under a temperature of 95° C., which is lower by 10° C., indicates the same change of −20% in 6000 hours, which is twice as long, for example.

In this case, the calculation unit 1003 calculates the amount of characteristic change of the part in accordance with the graph 1102. A graph 1103 represents a characteristic change when the temperature of the part is 85° C. Thus, in the case where the transportation condition when the candidate transportation route is used for the transportation is “85° C.,” the calculation unit 1003 calculates the amount of characteristic change of the part in accordance with the graph 1103.

Note that, when an appropriate acceleration formula is not available, the calculation unit 1003 may calculate the amount of characteristic change of the part using evaluation information regarding the transportation condition that causes the greatest characteristic change, for example. Also note that, as the evaluation information regarding each part in the part DB 220, evaluation information regarding each of a plurality of transportation conditions may be prepared. In this case, the calculation unit 1003 may calculate the amount of characteristic change of the part using the evaluation information regarding, out of the plurality of transportation conditions, the transportation condition that is closest to the transportation condition when the candidate transportation route (or the transportation stages) is used for the transportation.

Referring back to FIG. 10, the determination unit 1004 determines whether or not the calculated characteristic change of the part corresponding to the transportation time required when the first transportation route is passed through exceeds the threshold value. The threshold value may be set in any desired manner, and may be set in accordance with the device to be manufactured. The threshold value corresponds to, for example, an allowable range of a characteristic that may be identified from the allowable range table 700 in the device DB 230 illustrated in FIG. 7.

For example, the determination unit 1004 refers to the allowable range table 700 in the device DB 230, and identifies an allowable range of a characteristic that corresponds to a combination of the specified device to be manufactured and the specified part. In the case where the device to be manufactured is “device AP1” and the part is “part A,” for example, an allowable range concerning the characteristic “frequency” of part A, “±50 ppm,” is identified.

The determination unit 1004 determines whether or not the calculated amount of characteristic change of the part with respect to the candidate transportation route falls within the identified allowable range of the characteristic. Here, in the case where the amount of characteristic change of the part falls within the allowable range, the determination unit 1004 determines that the characteristic change of the part does not exceed the threshold value. Meanwhile, in the case where the amount of characteristic change of the part does not fall within the allowable range, the determination unit 1004 determines that the characteristic change of the part exceeds the threshold value.

In the case where it is determined that the characteristic change of the part exceeds the threshold value, the calculation unit 1003 calculates, with respect to the second transportation route, which is different from the first transportation route, the characteristic change of the part corresponding to the transportation time required when the second transportation route is passed through. In this case, the determination unit 1004 determines whether or not the calculated characteristic change of the part corresponding to the transportation time required when the second transportation route is passed through exceeds the threshold value.

Here, the second transportation route is a route that is different from the first transportation route in at least one of the places at which the part is procured (e.g., the part production place of the part vendor), the place at which the device to be manufactured is manufactured (e.g., the manufacturing location), and the transportation means (e.g., the road vehicle, the ship, the airplane, the railway vehicle, etc.), for example. The second transportation route may be acquired by the acquisition unit 1002 with a change in search conditions (e.g., the place at which the part is procured, the place at which the device to be manufactured is manufactured, the transportation means, etc.) when it has been determined that the characteristic change of the part exceeds the threshold value. The second transportation route may be a route included in the N transportation routes that have been discovered together with the first transportation route.

For example, eliminating the first transportation route from the candidate transportation routes, the calculation unit 1003 selects, out of the acquired transportation routes, a transportation route (i.e., the second transportation route) that is different from the first transportation route, and determines the selected transportation route (i.e., the second transportation route) to be the candidate transportation route. The calculation unit 1003 calculates the amount of characteristic change of the part with respect to the candidate transportation route. The determination unit 1004 determines whether or not the calculated amount of characteristic change of the part with respect to the candidate transportation route falls within the allowable range.

Note that the calculation unit 1003 may calculate the amount of characteristic change of the part with respect to each of the acquired transportation routes. For example, the calculation unit 1003 may determine each of the acquired transportation routes to be a candidate transportation route, and calculate the amount of characteristic change of the part with respect to each candidate transportation route.

When it has been determined that the characteristic change of the part corresponding to the transportation time required when the transportation route (e.g., the first transportation route) is passed through does not exceed the threshold value, the output unit 1005 outputs the information for identifying the transportation route. The information for identifying the transportation route may be, for example, information indicating the starting place, the passed-through place, the destination, the transportation means, etc., of the transportation route. Alternatively, the information for identifying the transportation route may be information of the transportation route plotted on map data.

The output of the output unit 1005 may be in the form of storing the information into a storage device, such as the memory 302, the disk 304, or the like, transmitting the information to another computer through the communication I/F 305, providing a printout of the information via a printer (not illustrated), or the like. For example, the output unit 1005 may output information for identifying the candidate transportation route with respect to which the amount of characteristic change of the part falls within the allowable range as the transportation route to be used to transport the specified part of the device to be manufactured.

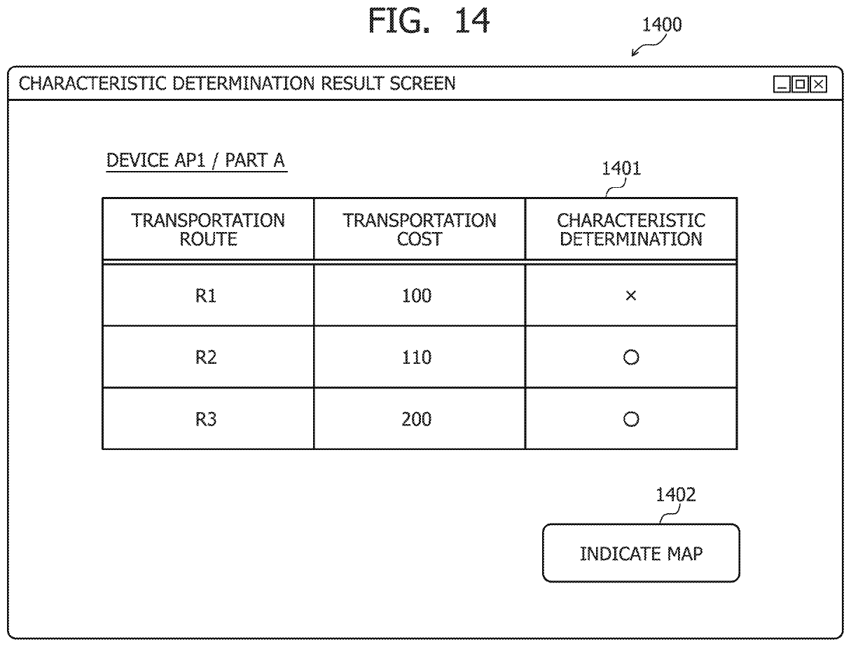

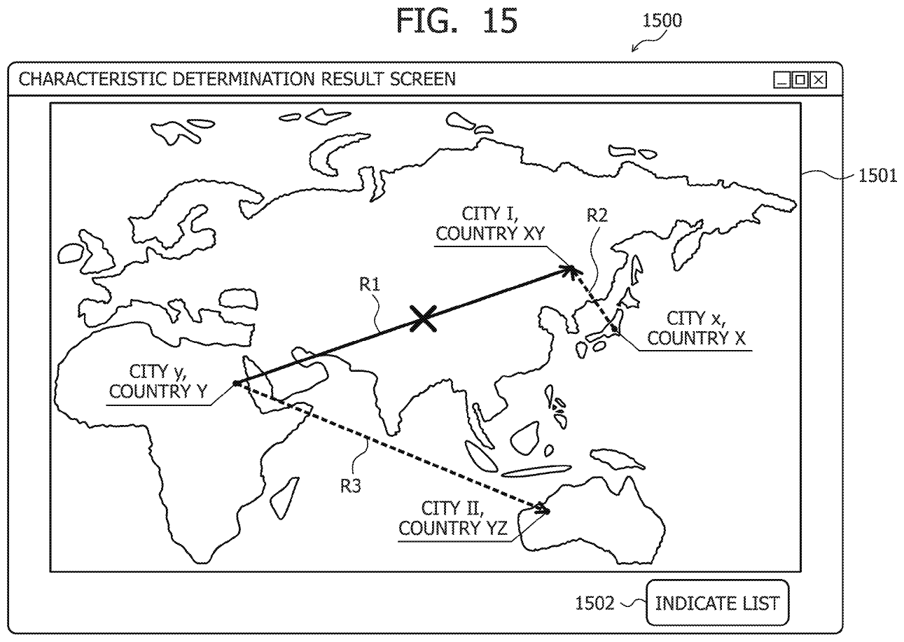

To describe in more detail, the output unit 1005 may display a characteristic determination result screen on the client device 201, for example. The characteristic determination result screen is an operation screen from which it is possible to identify the candidate transportation route with respect to which the amount of characteristic change of the part falls within the allowable range. Examples of the characteristic determination result screen will be described below with reference to FIGS. 14 and 15.

(Examples of Calculations of Amount of Characteristic Change of Part)

Next, examples of calculations of the amount of characteristic change of the part with respect to the candidate transportation route will be described below with reference to FIGS. 12A to 13B.

FIGS. 12A and 12B depict first explanatory diagrams illustrating an example of a calculation of the amount of characteristic change of the part. It is assumed here that the part is “part A,” and the characteristic of the part is “frequency.” It is also assumed that the candidate transportation route is a route including transportation stage i (an overland route), in which a road vehicle is used, transportation stage ii (a sea route), in which a ship is used, and transportation stage iii (an air route), in which an airplane is used.

It is also assumed that transportation stage i has transportation conditions, vibration “5 G,” temperature “45° C.,” and temperature change “Δ10° C., 5 cycles,” and that a transportation time required when transportation stage i is passed through is “2 h.” It is also assumed that transportation stage ii has transportation conditions, vibration “0.1 G,” temperature “25° C.,” and temperature change “Δ30° C., 20 cycles,” and that a transportation time required when transportation stage ii is passed through is “240 h.” It is also assumed that transportation stage iii has transportation conditions, vibration “0.2 G,” temperature “45° C.,” and temperature change “Δ20° C., 1 cycle,” and that a transportation time required when transportation stage iii is passed through is “5 h.”

In this case, the calculation unit 1003 calculates the amount of characteristic change of part A with respect to each of transportation stages i, ii, and iii. For example, with respect to “vibration,” the calculation unit 1003 refers to the characteristic change information 512 in the evaluation information 510 illustrated in FIG. 5A-1, and calculates the amount of characteristic change of part A corresponding to the transportation time, “2 h,” required when transportation stage i is passed through, based on the transportation condition (vibration “5 G”) of transportation stage i. However, the transportation conditions (vibrations “1 G” and “10 G”) in the characteristic change information 512 of the evaluation information 510 are different from the transportation condition (vibration “5 G”) of transportation stage i. Accordingly, the calculation unit 1003 calculates an approximation of the characteristic change of part A, for example. It is assumed here that an amount of characteristic change of part A, “−10 ppm,” is obtained with respect to “vibration.”

With respect to “temperature,” the calculation unit 1003 refers to the characteristic change information 514 of the evaluation information 510 illustrated in FIG. 5A-2, and calculates the amount of characteristic change of part A corresponding to the transportation time, “2 h,” required when transportation stage i is passed through, based on the transportation condition (temperature “45° C.”) of transportation stage i. However, the transportation conditions (temperatures “85° C.” and “105° C.”) in the characteristic change information 514 of the evaluation information 510 are different from the transportation condition (temperature “45° C.”) of transportation stage i. Accordingly, the calculation unit 1003 calculates an approximation of the characteristic change of part A, for example. It is assumed here that an amount of characteristic change of part A, “−0.1 ppm,” is obtained with respect to “temperature.”

With respect to “temperature change,” the calculation unit 1003 refers to the characteristic change information 516 of the evaluation information 510 illustrated in FIG. 5A-3, and calculates the amount of characteristic change of part A corresponding to a temperature change frequency of “5” when transportation stage i is passed through, based on the transportation condition (temperature change “Δ10° C.”) of transportation stage i. However, the transportation conditions (temperature changes “Δ125° C.” and “Δ180° C.”) in the characteristic change information 516 of the evaluation information 510 are different from the transportation condition (temperature change “Δ10° C.”) of transportation stage i. Accordingly, the calculation unit 1003 calculates an approximation of the characteristic change of part A, for example. It is assumed here that an amount of characteristic change of part A, “−5 ppm,” is obtained with respect to “temperature change.”

The calculation unit 1003 adds up the amounts of characteristic change of part A calculated with respect to “vibration,” “temperature,” and “temperature change,” and thereby calculates the amount of characteristic change of part A with respect to transportation stage i. Here, an amount of characteristic change of part A, “−15.1 ppm,” is obtained with respect to transportation stage i.

Similarly, the calculation unit 1003 calculates the amount of characteristic change of part A with respect to each of transportation stages ii and iii. It is assumed here that an amount of characteristic change of part A, “−40.33 ppm,” is obtained with respect to transportation stage ii, and that an amount of characteristic change of part A, “−5.26 ppm,” is obtained with respect to transportation stage iii.

The calculation unit 1003 adds up the amounts of characteristic change of part A calculated with respect to transportation stages i, ii, and iii, and thereby calculates the amount of characteristic change of part A with respect to the candidate transportation route. Here, an amount of characteristic change of part A, “−60.69 ppm,” is obtained with respect to the candidate transportation route. In FIGS. 12A and 12B, a graph 1201 represents the characteristic change of part A when transportation stages i, ii, and iii of the candidate transportation route are passed through.

Here, in the case where part A is used to manufacture device AP1, the allowable range of the characteristic “frequency” is “±50 ppm” (see FIG. 7). In this case, the determination unit 1004 determines that the amount of characteristic change of part A with respect to the candidate transportation route, “−60.69 ppm,” does not fall within the allowable range of the characteristic “frequency.” Meanwhile, in the case where part A is used to manufacture device AP2, the allowable range of the characteristic “frequency” is “±100 ppm” (see FIG. 7). In this case, the determination unit 1004 determines that the amount of characteristic change of part A with respect to the candidate transportation route, “−60.69 ppm,” falls within the allowable range of the characteristic “frequency.”

FIGS. 13A and 13B depict second explanatory diagrams illustrating an example of a calculation of the amount of characteristic change of the part. It is assumed here that the part is “part B,” and the characteristic of the part is capacitance. It is also assumed that the candidate transportation route is a route including transportation stage i (an overland route), in which a road vehicle is used, transportation stage ii (a sea route), in which a ship is used, and transportation stage iii (an air route), in which an airplane is used.

It is also assumed that transportation stage i has transportation conditions, vibration “5 G,” temperature “45° C.,” and temperature change “Δ10° C., 5 cycles,” and that a transportation time required when transportation stage i is passed through is “2 h.” It is also assumed that transportation stage ii has transportation conditions, vibration “0.1 G,” temperature “25° C.,” and temperature change “Δ30° C., 20 cycles,” and that a transportation time required when transportation stage ii is passed through is “240 h.” It is also assumed that transportation stage iii has transportation conditions, vibration “0.2 G,” temperature “45° C.,” and temperature change “Δ20° C., 1 cycle,” and that a transportation time required when transportation stage iii is passed through is “5 h.”

In this case, the calculation unit 1003 calculates the amount of characteristic change of part B with respect to each of transportation stages i, ii, and iii. For example, with respect to “vibration,” the calculation unit 1003 refers to the characteristic change information 522 in the evaluation information 520 illustrated in FIG. 5B-1, and calculates the amount of characteristic change of part B corresponding to the transportation time, “2 h,” required when transportation stage i is passed through, based on the transportation condition (vibration “5 G”) of transportation stage i. It is assumed here that an amount of characteristic change of part B, “−0.2%,” is obtained with respect to “vibration.”

With respect to temperature, the calculation unit 1003 refers to the characteristic change information 524 of the evaluation information 520, and calculates the amount of characteristic change of part B corresponding to the transportation time, “2 h,” required when transportation stage i is passed through, based on the transportation condition (temperature “45° C.”) of transportation stage i. It is assumed here that an amount of characteristic change of part B, “0%,” is obtained with respect to temperature.

With respect to temperature change, the calculation unit 1003 refers to the characteristic change information 526 of the evaluation information 520, and calculates the amount of characteristic change of part B corresponding to a temperature change frequency of “5” when transportation stage i is passed through, based on the transportation condition (temperature change “Δ10° C.”) of transportation stage i. It is assumed here that an amount of characteristic change of part B, “−0.05%,” is obtained with respect to temperature change.

The calculation unit 1003 adds up the amounts of characteristic change of part B calculated with respect to vibration, temperature, and temperature change, and thereby calculates the amount of characteristic change of part B with respect to transportation stage i. Here, an amount of characteristic change of part B, “−0.25%,” is obtained with respect to transportation stage i.

Similarly, the calculation unit 1003 calculates the amount of characteristic change of part B with respect to each of transportation stages ii and iii. It is assumed here that an amount of characteristic change of part B, “−0.383%,” is obtained with respect to transportation stage ii, and that an amount of characteristic change of part B, “−0.1%,” is obtained with respect to transportation stage iii.

The calculation unit 1003 adds up the amounts of characteristic change of part B calculated with respect to transportation stages i, ii, and iii, and thereby calculates the amount of characteristic change of part B with respect to the candidate transportation route. Here, an amount of characteristic change of part B, “−0.733%,” is obtained with respect to the candidate transportation route. In FIGS. 13A and 13B, a graph 1301 represents the characteristic change of part B when transportation stages i, ii, and iii of the candidate transportation route are passed through.

Here, in the case where part B is used to manufacture device AP1, the allowable range of the characteristic capacitance is “±10%” (see FIG. 7). In this case, the determination unit 1004 determines that the amount of characteristic change of part B with respect to the candidate transportation route, “−0.733%,” falls within the allowable range of the characteristic capacitance. Meanwhile, in the case where part B is used to manufacture device AP2, the allowable range of the characteristic capacitance is “±15%” (see FIG. 7). In this case, the determination unit 1004 determines that the amount of characteristic change of part B with respect to the candidate transportation route, “−0.733%,” falls within the allowable range of the characteristic capacitance.

(Examples of Characteristic Determination Result Screen)

Next, examples of the characteristic determination result screen displayed on the client device 201 will be described below with reference to FIGS. 14 and 15.

Each of FIGS. 14 and 15 is an explanatory diagram illustrating an example of the characteristic determination result screen. In FIG. 14, a characteristic determination result screen 1400 is an operation screen from which it is possible to identify candidate transportation routes with respect to which the amount of characteristic change of part A falls within the allowable range, as transportation routes along which part A, which is used to manufacture device AP1, which is the device to be manufactured, is transported.

In the characteristic determination result screen 1400, a transportation route list 1401 is indicated. The transportation route list 1401 is information that indicates transportation routes R1, R2, and R3 for part A in list form. The transportation cost indicates a transportation cost required when part A is transported along each transportation route. The characteristic determination indicates whether or not the amount of characteristic change of part A falls within the allowable range. In the characteristic determination, “◯” indicates that the amount of characteristic change of part A falls within the allowable range, while “x” indicates that the amount of characteristic change of part A does not fall within the allowable range.

From the characteristic determination result screen 1400, the user of the client device 201 is able to grasp that, with respect to transportation route R1, the transportation cost is the lowest of all, but the amount of characteristic change of part A does not fall within the allowable range. The user is also able to grasp that there are transportation routes R2 and R3, with respect to which the transportation cost is higher than transportation route R1, but the amount of characteristic change of part A falls within the allowable range. As a result, the user is able to select, for example, transportation route R2, which involves as low a cost as possible and does not significantly affect the performance or quality of part A, as the transportation route for part A.

If, in the characteristic determination result screen 1400, a button 1402 is selected by an input operation by the user using the input device (not illustrated), the screen displayed may be switched to a characteristic determination result screen 1500 as illustrated in FIG. 15.

In FIG. 15, map data 1501 is indicated in the characteristic determination result screen 1500. On the map data 1501, transportation routes R1 to R3 are plotted. Transportation route R1, with respect to which the amount of characteristic change of part A does not fall within the allowable range, is marked with “x.”

From the characteristic determination result screen 1500, the user is able to roughly recognize transportation routes R1 to R3, which are the candidate transportation routes for part A, which is used to manufacture device AP1. The user is also able to intuitively grasp whether or not the amount of characteristic change of part A falls within the allowable range with respect to each of transportation routes R1 to R3.

If, in the characteristic determination result screen 1500, a button 1502 is selected by an input operation by the user using the input device (not illustrated), the screen displayed may be switched to the characteristic determination result screen 1400 illustrated in FIG. 14.

(Procedure of Transportation Route Calculation Performed by Information Processing Device 101)

Next, a procedure of transportation route calculation performed by the information processing device 101 will be described below.

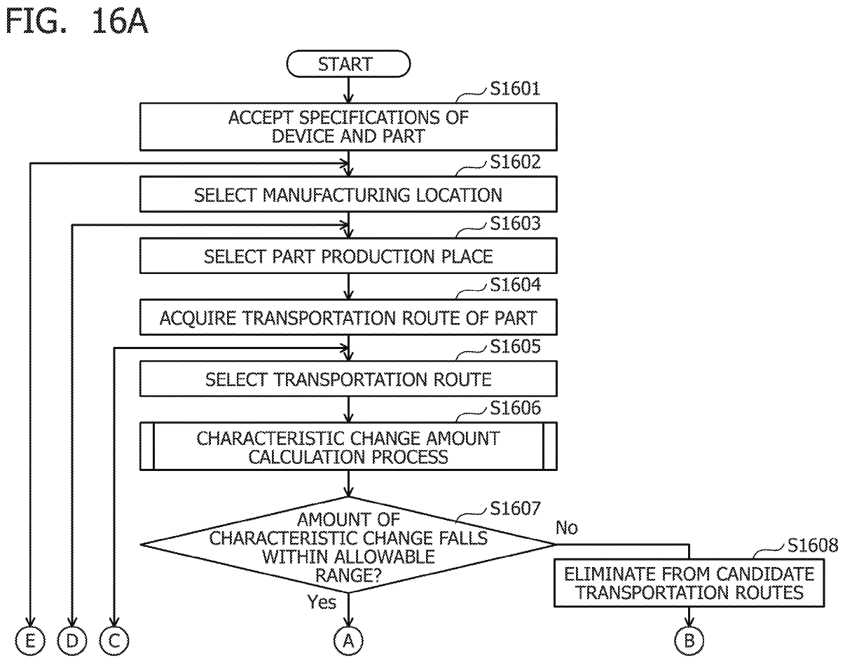

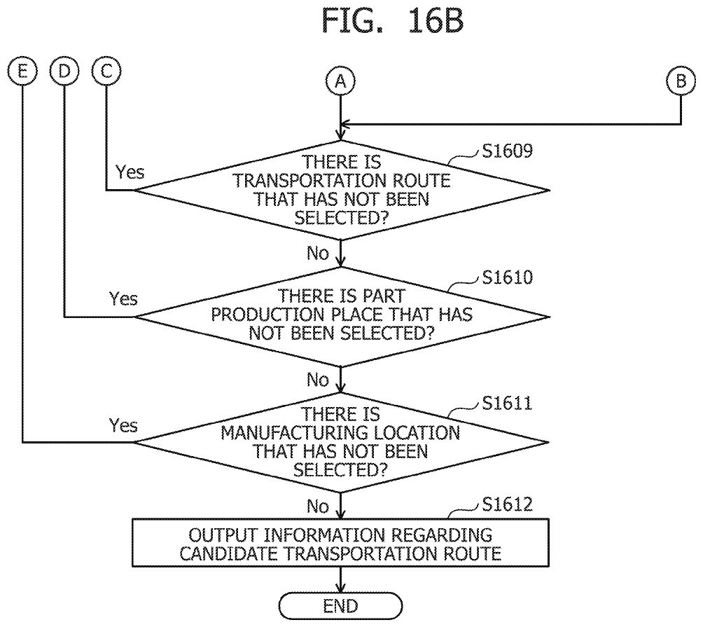

FIGS. 16A and 16B depict flowcharts illustrating an example of the procedure of the transportation route calculation performed by the information processing device 101. In the flowcharts of FIGS. 16A and 16B, the information processing device 101 accepts the specification of the device to be manufactured, and the specification of the part with respect to which the transportation route is to be searched for among the parts used to manufacture the device to be manufactured (step S1601).

The information processing device 101 refers to the manufacturing location table 800 in the manufacture DB 240, and selects a manufacturing location that has not been selected from among a manufacturing location corresponding to the specified device to be manufactured (step S1602). The information processing device 101 refers to the vendor information table 400 in the part DB 220, and selects a part production place that has not been selected from among a part production place corresponding to the specified part (step S1603).

The information processing device 101 acquires a transportation route of the part from the selected part production place to the selected manufacturing location (step S1604). The information processing device 101 selects a transportation route that has not been selected from among the acquired transportation route (step S1605).

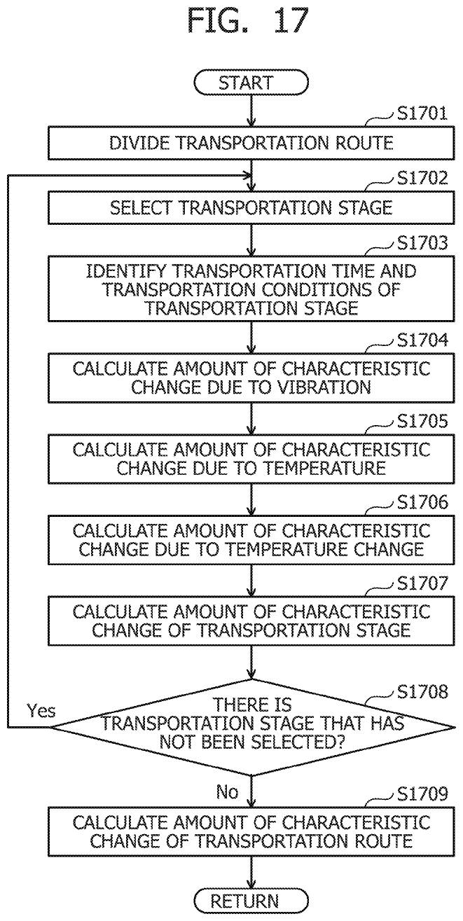

The information processing device 101 performs a characteristic change amount calculation process, which is a process of calculating the amount of characteristic change of the part when the selected transportation route is passed through (step S1606). A specific procedure of the characteristic change amount calculation process will be described below with reference to FIG. 17.

The information processing device 101 refers to the allowable range table 700 in the device DB 230, and determines whether or not the calculated amount of characteristic change of the part falls within the allowable range (step S1607). When the calculated amount of characteristic change falls within the allowable range (step S1607: Yes), the information processing device 101 proceeds to step S1609.

Meanwhile, when the calculated amount of characteristic change does not fall within the allowable range (step S1607: No), the information processing device 101 eliminates the selected transportation route from the candidate transportation routes (step S1608). The information processing device 101 determines whether or not there is a transportation route that has not been selected among the acquired transportation route (step S1609).

When there is a transportation route that has not been selected (step S1609: Yes), the information processing device 101 returns to step S1605. Meanwhile, when there is not a transportation route that has not been selected (step S1609: No), the information processing device 101 refers to the vendor information table 400, and determines whether or not there is a part production place that has not been selected among the part production place corresponding to the specified part (step S1610).

When there is a part production place that has not been selected (step S1610: Yes), the information processing device 101 returns to step S1603. Meanwhile, when there is not a part production place that has not been selected (step S1610: No), the information processing device 101 refers to the manufacturing location table 800, and determines whether or not there is a manufacturing location that has not been selected among the manufacturing location corresponding to the specified device to be manufactured (step S1611).

When there is a manufacturing location that has not been selected (step S1611: Yes), the information processing device 101 returns to step S1602. Meanwhile, when there is not a manufacturing location that has not been selected (step S1611: No), the information processing device 101 outputs information for identifying the candidate transportation route (step S1612), completing the series of processes according to this flowchart. The candidate transportation route is a transportation route with respect to which the amount of characteristic change of the part falls within the allowable range.

Thus, information for identifying the transportation route with respect to which the amount of characteristic change during transportation falls within the allowable range may be provided with respect to the part used to manufacture the device to be manufactured.

Although it has been assumed here that the specification of the part with respect to which the transportation route is to be searched for is accepted, the present technology is not limited to this. For example, the transportation routes may be searched for with respect to all of the parts used to manufacture the device to be manufactured. Although it has also been assumed here that the transportation routes are acquired with respect to all manufacturing locations corresponding to the device to be manufactured, the present technology is not limited to this. For example, the transportation route may be acquired with respect to only one or more specified manufacturing locations among all the manufacturing locations corresponding to the device to be manufactured.

Next, the specific procedure of the characteristic change amount calculation process performed at step S1606 illustrated in FIG. 16A will be described below.

FIG. 17 is a flowchart illustrating an example specific procedure of the characteristic change amount calculation process. In the flowchart of FIG. 17, the information processing device 101 refers to the transportation condition DB 250, and divides the selected transportation route into a plurality of transportation stages based on the transportation conditions when the selected transportation route is used for the transportation (step S1701).

The information processing device 101 selects a transportation stage that has not been selected from among the divided transportation stages (step S1702). The information processing device 101 refers to the transportation condition DB 250, and identifies the transportation time required when the selected transportation stage is passed through, and the transportation conditions (e.g., vibration, temperature, and temperature change frequency) when the selected transportation stage is used for the transportation (step S1703).

The information processing device 101 refers to the evaluation information (e.g., the evaluation information 510 or 520) regarding the specified part within the part DB 220, and calculates the amount of characteristic change of the part due to the vibration and corresponding to the identified transportation time, based on the identified transportation condition (vibration) (step S1704). The information processing device 101 refers to the evaluation information regarding the specified part within the part DB 220, and calculates the amount of characteristic change of the part due to the temperature and corresponding to the identified transportation time, based on the identified transportation condition (temperature) (step S1705). The information processing device 101 refers to the evaluation information regarding the specified part within the part DB 220, and calculates the amount of characteristic change of the part due to the temperature change, based on the identified transportation condition (temperature change frequency) (step S1706).

The information processing device 101 adds up the amounts of characteristic change calculated at steps S1704 to S1706, and thereby calculates the amount of characteristic change of the part with respect to the selected transportation stage (step S1707). The information processing device 101 determines whether or not there is a transportation stage that has not been selected among the divided transportation stages (step S1708).

Here, when there is a transportation stage that has not been selected (step S1708: Yes), the information processing device 101 returns to step S1702. Meanwhile, when there is not a transportation stage that has not been selected (step S1708: No), the information processing device 101 adds up the amounts of characteristic change of the part calculated with respect to the respective transportation stages, and thereby calculates the amount of characteristic change of the part with respect to the selected transportation route (step S1709), returning to the step from which the characteristic change amount calculation process was called.

The amount of characteristic change of the part when the transportation route is passed through may thus be calculated.

As described above, according to the information processing device 101 according to an embodiment, with reference to the information (e.g., the evaluation information 510 or 520 in the part DB 220) indicating the relationships between conditions when a part is transported, transportation times of the part, and characteristic changes of the part, it may be determined whether or not the characteristic change of the part corresponding to the transportation time required when the first transportation route is passed through exceeds the threshold value based on the transportation conditions when the first transportation route is used for the transportation. According to the information processing device 101, when it has been determined that the characteristic change of the part does not exceed the threshold value, the information for identifying the first transportation route is outputted, whereas when it has been determined that the characteristic change of the part exceeds the threshold value, the above determination may be performed with respect to the second transportation route, which is different from the first transportation route. The first transportation route is, for example, a route from a place at which the part is procured to a place at which the device to be manufactured is manufactured.

Thus, an appropriate transportation route may be obtained with a change in characteristics (e.g., a change in frequency, a change in capacitance, etc.) that is expected to occur during the transportation of the part taken into consideration.

According to the information processing device 101, it may be determined whether or not the characteristic change of the part corresponding to the transportation time required when the first transportation route is passed through exceeds the threshold value based on the magnitude of vibration when the first transportation route is used for the transportation.

Thus, a transportation route that allows the characteristic change of the part due to the magnitude of vibration during the transportation of the part to fall within the allowable range may be obtained. Thus, even when the part to be transported is a part that may be easily affected by vibration, it is possible to decide on a transportation route that involves a relatively low cost and which ensures that the performance and quality of the part will be maintained at required levels.

According to the information processing device 101, it may be determined whether or not the characteristic change of the part corresponding to the transportation time required when the first transportation route is passed through exceeds the threshold value based on the temperature when the first transportation route is used for the transportation.

Thus, a transportation route that allows the characteristic change of the part due to the temperature during the transportation of the part to fall within the allowable range may be obtained. Thus, even when the part to be transported is a part that may be easily affected by temperature, it is possible to decide on a transportation route that involves a relatively low cost and which ensures that the performance and quality of the part will be maintained at required levels.

According to the information processing device 101, with reference to the information (e.g., the evaluation information 510 or 520 in the part DB 220) indicating the relationships between characteristic changes of the part and the numbers of times a temperature change occurs during the transportation of the part, it may be determined whether or not the characteristic change of the part corresponding to the number of times a temperature change occurs when the first transportation route is passed through exceeds the threshold value.

Thus, a transportation route that allows the characteristic change of the part due to the temperature change during the transportation of the part to fall within the allowable range may be obtained. Thus, even when the part to be transported is a part that may be easily affected by temperature change, it is possible to decide on a transportation route that involves a relatively low cost and which ensures that the performance and quality of the part will be maintained at required levels.

According to the information processing device 101, a route that is different from the first transportation route in at least one of the place at which the part is procured, the place at which the device to be manufactured is manufactured, and the transportation means may be set as the second transportation route.

Thus, a transportation route that allows the characteristic change of the part due to the vibration, temperature, temperature change, or the like during the transportation of the part to fall within the allowable range may be obtained with a change in the place at which the part is procured, the place at which the device to be manufactured is manufactured, the transportation means, or the like.

According to the information processing device 101, the first transportation route may be divided into a plurality of transportation stages based on the conditions when the first transportation route is used for the transportation, and, with respect to each of the divided transportation stages, the characteristic change of the part corresponding to the number of times of temperature changes or the transportation time when the transportation stage is passed through may be calculated based on the conditions when the transportation stage is used for the transportation. According to the information processing device 101, the characteristic change of the part corresponding to the transportation time required when the first transportation route is passed through may be calculated based on the characteristic changes of the part calculated with respect to the respective transportation stages, and it may be determined whether or not the calculated characteristic change of the part exceeds the threshold value.

Thus, even when a change in the transportation conditions occurs along the first transportation route, the characteristic change of the part with respect to the whole first transportation route may be accurately calculated by adding up the characteristic changes of the part calculated with respect to the respective transportation stages, each of which has the same transportation conditions.

According to the information processing device 101, the threshold value concerning the characteristic change of the part may be set in accordance with the device to be manufactured.

Thus, a transportation route that ensures that the performance and quality of the part will be maintained at levels required by the device to be manufactured may be obtained.

According to the information processing device 101, when it has been determined that the characteristic change of the part does not exceed the threshold value, information of the first transportation route plotted on map data may be outputted.

Thus, it may be possible to provide a display that enables a user to easily and intuitively grasp a transportation route that allows the characteristic change during the transportation of the part to fall within the allowable range.

When the information processing device 101, having the above-described features, is used, it may be possible to decide on a low-cost procurement plan (i.e., a low-cost transportation route) that does not involve a significant unwanted effect on the quality or performance of the part even when the part to be transported is a part sensitive to the transportation conditions (e.g., vibration, temperature, temperature change, etc.). For example, if a transportation route that does not allow a transportation therealong to produce a significant unwanted effect may be obtained, it may be possible to reduce a need for an operation such as packing the part by a special method, and thus to achieve a reduction in cost required for the transportation of the part. Further, it may become possible to decide on an optimum procurement plan about the device to be manufactured as a whole by using a procurement plan about each part of the device obtained with the transportation cost thereof taken into consideration.

The transportation route calculation method according to the present embodiment described above may be implemented by a computer, such as a personal computer or a workstation, executing a program prepared in advance. A transportation route calculation program according to an embodiment of the present technology is recorded on a computer-readable recording medium, such as a hard disk, a flexible disk, a CD-ROM, a magneto-optical (MO) disk, a DVD, or a USB memory, and is executed by the computer by reading the transportation route calculation program from the recording medium. Alternatively, the transportation route calculation program according to an embodiment of the present technology may be delivered via a network, such as the Internet.

The information processing device 101 according to the present embodiment described above may also be implemented by an IC designed for a specific use, such as a standard cell or a structured application-specific integrated circuit (ASIC), or by a programmable logic device (PLD), such as a field programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process comprising:
referring to information indicating relationships between conditions when a part is transported, transportation times of the part, and characteristic changes of the part, and making a determination of whether or not a characteristic change of the part corresponding to a transportation time required when a first transportation route is passed through exceeds a threshold value based on conditions when the first transportation route is used for transporting the part;
when it has been determined that the threshold value is not exceeded, outputting information for identifying the first transportation route; and
when it has been determined that the threshold value is exceeded, making the determination with respect to a second transportation route different from the first transportation route.

2. The non-transitory, computer-readable recording medium of claim 1, wherein
the conditions are expressed by at least one of a magnitude of vibration and temperature during transporting of the part.

3. The non-transitory, computer-readable recording medium of claim 1, the process further comprising:
referring to information indicating relationships between characteristic changes of the part and numbers of times a temperature change occurs during transporting of the part, and determining whether or not a characteristic change of the part corresponding to number of times a temperature change occurs when the first transportation route is passed through exceeds a threshold value.

4. The non-transitory, computer-readable recording medium of claim 1, wherein
the first transportation route is a route from a place at which the part is procured to a place at which a device to be manufactured using the part is manufactured; and
the second transportation route is a route different from the first transportation route in at least one of the place at which the part is procured, the place at which the device is manufactured, and transportation means.

5. The non-transitory, computer-readable recording medium of claim 1, the process further comprising:
dividing the first transportation route into a plurality of transportation stages based on the conditions when the first transportation route is used for transporting the part;
with respect to each of the plurality of transportation stages, calculating a characteristic change of the part corresponding to a transportation time required when the transportation stage is passed through, based on conditions when the transportation stage is used for transporting the part;
calculating the characteristic change of the part corresponding to the transportation time required when the first transportation route is passed through, based on the characteristic changes of the part calculated with respect to the respective transportation stages; and
determining whether or not the calculated characteristic change of the part corresponding to the transportation time required when the first transportation route is passed through exceeds the threshold value.

6. The non-transitory, computer-readable recording medium of claim 1, the process further comprising:
identifying the conditions when the first transportation route is used for transporting the part, and the transportation time required when the first transportation route is passed through, by referring to information indicating relationships between transportation routes, transportation times required when respective transportation routes are passed through, and conditions when respective transportation routes are used for transporting the part, wherein
the determining is determining whether or not the characteristic change of the part corresponding to the identified transportation time required when the first transportation route is passed through exceeds the threshold value based on the identified conditions when the first transportation route is used for transporting the part.

7. The non-transitory, computer-readable recording medium of claim 1, wherein
the threshold value is set in accordance with a device to be manufactured using the part.

8. The non-transitory, computer-readable recording medium of claim 1, wherein
the information for identifying the first transportation route is information of the first transportation route plotted on map data.

9. A method performed by a computer, the method comprising:
referring to information indicating relationships between conditions when a part is transported, transportation times of the part, and characteristic changes of the part, and making a determination of whether or not a characteristic change of the part corresponding to a transportation time required when a first transportation route is passed through exceeds a threshold value based on conditions when the first transportation route is used for transporting the part;
when it has been determined that the threshold value is not exceeded, outputting information for identifying the first transportation route; and
when it has been determined that the threshold value is exceeded, making the determination with respect to a second transportation route different from the first transportation route.

10. An information processing apparatus comprising:
a memory; and
a processor coupled to the memory and configured to:
refer to information indicating relationships between conditions when a part is transported, transportation times of the part, and characteristic changes of the part, and make a determination of whether or not a characteristic change of the part corresponding to a transportation time required when a first transportation route is passed through exceeds a threshold value based on conditions when the first transportation route is used for transporting the part,
when it has been determined that the threshold value is not exceeded, output information for identifying the first transportation route, and
when it has been determined that the threshold value is exceeded, make the determination with respect to a second transportation route different from the first transportation route.
